(19) United States
(12) Patent Application Publication
(10) Pub. No.: US 2014/0200136 A1
(43) Pub. Date: Jul. 17, 2014

(54) Agricultural mixtures comprising arylquinazolinone compounds

(71) Applicants: Florian Kaiser, Mannheim (DE); Steffen Gross, Ludwigshafen (DE); Egon Haden, Speyer (DE); Arun Narine, Mannheim (DE)

(72) Inventors: Florian Kaiser, Mannheim (DE); Steffen Gross, Ludwigshafen (DE); Egon Haden, Speyer (DE); Arun Narine, Mannheim (DE)

(73) Assignee: BASF SE, Ludwigshafen (DE)

(21) Appl. No.: 14/241,270

(22) PCT Filed: Aug. 31, 2012
(86) PCT No.: PCT/EP2012/066963

§ 371 Date: Feb. 26, 2014

Related U.S. Application Data
(60) Provisional application No. 61/530,457, filed on Sep. 2, 2011.

(51) Int. Cl. A01N 43/54; A01N 37/50; A01N 43/40; A01N 43/50; A01N 43/52; A01N 37/34; A01N 43/88; A01N 43/56; A01N 47/14; A01N 47/24

(52) U.S. Cl. CPC A01N 43/54; A01N 47/14; A01N 37/50; A01N 43/40; A01N 47/24; A01N 43/52; A01N 37/34; A01N 43/88; A01N 43/56; A01N 43/50
USPC 504/100; 514/266.3; 514/229.2; 514/259.31; 514/63; 514/266.23; 514/237.5; 424/705; 424/633; 424/632; 424/637; 424/638; 514/491

(57) ABSTRACT

The present invention relates to pesticidal mixtures comprising as active compounds

1) at least one pesticidal active 3-arylquinazolin-4-one compound I of formula (I):

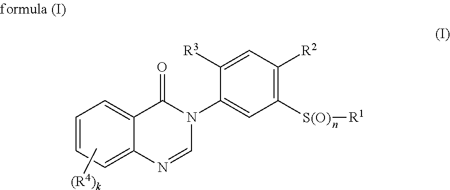

wherein R¹, R², R³, R⁴, k and n are defined in the description;
and

2) at least one fungicidal compounds II selected from azoles, strobilurins, carboxamides, carbamates, heterocyclic and various other compounds as defined in the description, in synergistically effective amounts.

The invention relates further to methods and use of these mixtures for combating insects, arachnids or nematodes and harmful fungis in and on plants, and for protecting such plants being infested with pests, especially also for protecting seeds.

The present invention relates to mixtures of active ingredients having synergistically enhanced action and to methods comprising applying said mixtures.

One typical problem arising in the field of pest and/or fungi control lies in the need to reduce the dosage rates of the active ingredient in order to reduce or avoid unfavorable environmental or toxicological effects whilst still allowing effective pest and/or fungi control.

Another problem encountered concerns the need to have available pesticidal active agents which are effective against a broad spectrum of pests.

Another problem encountered concerns the need to have available fungicidal active agents which are effective against a broad spectrum of fungi.

Another problem underlying the present invention is the desire for compositions that improve plants, a process which is commonly and hereinafter referred to as “plant health”. For example, advantageous properties that may be mentioned are improved crop characteristics including: emergence, crop yields, protein content, more developed root system, tillering increase, increase in plant height, bigger leaf blade, less dead basal leaves, stronger tillers, greener leaf color, pigment content, photosynthetic activity, less fertilizers needed, less seeds needed, more productive tillers, earlier flowering, early grain maturity, less plant verse (lodging), increased shoot growth, enhanced plant vigor, increased plant stand and early germination; or any other advantages familiar to a person skilled in the art. Methods for improving the health of plants by applying active compounds to the plants or the locus are a general need.

It is also an object of the present invention, with a view to reducing the application rates and broadening the activity spectrum of the active compounds I and II, to provide mixtures which, at a reduced total amount of active compounds applied, have improved activity against harmful fungi and animal pests.

It was therefore an object of the present invention to provide pesticidal mixtures which solve the problems outlined above.

The combating of harmful phytopathogenic fungi is in many regions not the only problem the farmer has to face. Also harmful insects can cause a great damage to crops and other plants. An efficient combination of fungicidal and insecticidal activity is desirable to overcome this problem. Thus, it is a further object of the present invention to provide a mixture which, on the one hand, has good fungicidal activity, and, on the other hand, good insecticidal activity, resulting in a broader pesticidal spectrum of action. There also exists the need for pest or fungi control agents that combine know-down activity with prolonged control, that is, fast action with long lasting action.

Another difficulty in relation to the use of pesticides or fungicides is that the repeated and exclusive application of an individual pesticidal compound leads in many cases to a rapid selection of pests which have developed natural or adapted resistance against the active compound in question. Therefore there is a need for pest or fungi control agents that help prevent or overcome resistance.

It was therefore an object of the present invention to provide agricultural mixtures which solves at least one of the discussed problems as reducing the dosage rate, enhancing the spectrum of activity or combining know-down activity with prolonged control or as to resistance management.

It has been found that this object is in part or in whole achieved by the combination of active compounds defined below.

The present invention relates to agricultural mixtures comprising as active compounds
1) at least one pesticidal active 3-arylquinazolin-4-one compound I of formula (I):

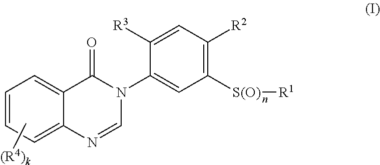

wherein
R¹ is C₁-C₄-alkyl, fluorinated C₁-C₄-alkyl, C₂-C₄-alkenyl, fluorinated C₂-C₄-alkenyl, cyclopropyl or cyclopropylmethyl;
R² is hydrogen, halogen, CN, C₁-C₄-alkyl or C₁-C₄-haloalkyl;
R³ is hydrogen, halogen, CN, C₁-C₄-alkyl or C₁-C₄-haloalkyl;
R⁴ is selected independently from the integer of k from the group consisting of halogen, CN, NO₂, C₁-C₄-haloalkyl, C₂-C₄-alkenyl, C₁-C₄-haloalkenyl, C₂-C₄-alkynyl, C₁-C₄-haloalkynyl, C₁-C₄-alkoxy-C₁-C₄-alkyl, C₁-C₄-alkoxy, C₁-C₄-haloalkoxy, C₁-C₄-haloalkylthio, C₁-C₄-alkylsulfinyl, C₁-C₄-alkylsulfonyl and C₁-C₄-haloalkylsulfonyl;
k is 0, 1, 2, 3 or 4;
and
n is 0, 1 or 2;
or the tautomers, enantiomers, diastereomers or salts thereof,
   and
2) at least one fungicidal active compound II selected from group F consisting of
F.I) Respiration inhibitors
   a) Inhibitors of complex III at Qₒ site (e.g. strobilurins): azoxystrobin, coumethoxystrobin, coumoxystrobin, dimoxystrobin, enestroburin, fenaminstrobin, fenoxystrobin/flufenoxystrobin, fluoxastrobin, kresoxim-methyl, meto-minostrobin, orysastrobin, picoxy-strobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-di-chlorophenyl)-1-methyl-allylidene-aminooxy-methyl)-phenyl)-2-methoxyimino-N-methyl-acetamide, pyribencarb, triclopyricarb/chlorodincarb, famoxadone, fenamidone;
   b) inhibitors of complex III at Qᵢ site: cyazofamid, amisulbrom;
   c) inhibitors of complex II (e.g. carboxamides): benodanil, bixafen, boscalid, carboxin, fen-furam, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide and N-(2-(1,3,3-trimethyl-butyl)-phenyl)-1,3-dimethyl-5-fluoro-1H-pyrazole-4-carboxamide;
   d) other respiration inhibitors (e.g. complex I, uncouplers): diflumetorim; nitrophenyl derivates: binapacryl, dinobuton, dinocap, fluazinam; ferimzone; organometal compounds: fentin salts, such as fentin-acetate, fentin chloride or fentin hydroxide; ametoctradin; and silthiofam;
F.II) Sterol biosynthesis inhibitors (SBI fungicides)
   a) C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothio-conazole, simeconazole, tebuconazole, tetraconazole, triadimefon, triadimenol, triticonazole, uniconazole; imidazoles: imazalil, pefurazoate, prochloraz, triflumizol; pyrimidines, pyridines and piperazines: fenarimol, nuarimol, pyrifenox, triforine;
   b) Delta14-reductase inhibitors: aldimorph, dodemorph, dodemorph-acetate, fenpropimorph, tridemorph, fenpropidin, piperalin, spiroxamine;
   c) Inhibitors of 3-keto reductase: fenhexamid;
F.III) Nucleic acid synthesis inhibitors
   a) phenylamides or acyl amino acid fungicides: benalaxyl, benalaxyl-M, kiralaxyl, metalaxyl, metalaxyl-M (mefenoxam), ofurace, oxadixyl;
   b) others: hymexazole, octhilinone, oxolinic acid, bupirimate;
F.IV) Inhibitors of cell division and cytoskeleton
   a) tubulin inhibitors, such as benzimidazoles, thiophanates: benomyl, carbendazim, fuberidazole, thiabendazole, thiophanate-methyl; triazolopyrimidines: 5-chloro-7-(4-methyl-piperidin-1-yl)-6-(2,4,6-trifluorophenyl)-[1,2,4]triazolo[1,5-a]pyrimidine
   b) other cell division inhibitors: diethofencarb, ethaboxam, pencycuron, fluopicolide, zoxamide, metrafenone, pyriofenone;
F.V) Inhibitors of amino acid and protein synthesis
   a) methionine synthesis inhibitors (anilino-pyrimidines): cyprodinil, mepanipyrim, pyrimethanil;
   b) protein synthesis inhibitors: blasticidin-S, kasugamycin, kasugamycin hydrochloride-hydrate, mildiomycin, streptomycin, oxytetracyclin, polyoxine, validamycin A;
F.VI) Signal transduction inhibitors
   a) MAP/histidine kinase inhibitors: fluoroimid, iprodione, procymidone, vinclozolin, fenpiclonil, fludioxonil;
   b) G protein inhibitors: quinoxyfen;
F.VII) Lipid and membrane synthesis inhibitors
   a) Phospholipid biosynthesis inhibitors: edifenphos, iprobenfos, pyrazophos, isoprothiolane;
   b) lipid peroxidation: dicloran, quintozene, tecnazene, tolclofos-methyl, biphenyl, chloroneb, etridiazole;
   c) phospholipid biosynthesis and cell wall deposition: dimethomorph, flumorph, mandipropamid, pyrimorph, benthiavalicarb, iprovalicarb, valifenalate and N-(1-(1-(4-cyano-phenyl)-ethanesulfonyl)-but-2-yl)carbamic acid-(4-fluorophenyl)ester;
   d) compounds affecting cell membrane permeability and fatty acids: propamocarb, propamocarb-hydrochlorid;
F.VIII) Inhibitors with Multi Site Action
   a) inorganic active substances: Bordeaux mixture, copper acetate, copper hydroxide, copper oxychloride, basic copper sulfate, sulfur;
   b) thio- and dithiocarbamates: ferbam, mancozeb, maneb, metam, metiram, propineb, thiram, zineb, ziram;
   c) organochlorine compounds (e.g. phthalimides, sulfamides, chloronitriles): anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-N-ethyl-4-methyl-benzenesulfonamide;
   d) guanidines and others: guanidine, dodine, dodine free base, guazatine, guazatine-acetate, iminoctadine, iminoctadine-triacetate, iminoctadine-tris(albesilate), dithianon;
F.IX) Cell wall synthesis inhibitors
   inhibitors of glucan synthesis: validamycin, polyoxin B; melanin synthesis inhibitors: pyroquilon, tricyclazole, carpropamid, dicyclomet, fenoxanil;
F.X) Plant defense inducers
   acibenzolar-5-methyl, probenazole, isotianil, tiadinil, prohexadione-calcium; phosphonates: fosetyl, fosetyl-aluminum, phosphorous acid and its salts;
F.XI) Unknown mode of action
   bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxin-copper, proquinazid, tebufloquin, tecloftalam, triazoxide, 2-butoxy-6-iodo-3-propylchromen-4-one, N-(cyclo-propylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethyl-silanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester, N-Methyl-2-{1-[(5-methyl-3-trifluoromethyl-1H-pyrazol-1-yl)-acetyl]-piperidin-4-yl}-N-[(1R)-1,2,3,4-tetrahydro-naphthalen-1-yl]-4-thiazolecarboxamide, 3-[5-(4-methyl-phenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl)cyclopropane-carboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide;
      in synergistically effective amounts.

Moreover, it has been found that simultaneous, that is joint or separate, application of one or more active compound(s) I and one or more compound(s) II or successive application (that is immediately one after another and thereby creating the mixture “in-situ” on the desired location, as e.g. the plant) of one or more active compound(s) I and one or more active compound(s) II allows enhanced control of pests and/or fungi compared to the control rates that are possible with the individual compounds.

Moreover, the present invention relates to:
agricultural compositions comprising a mixture of at least one active compound I and at least one active compound II;
the use of a mixture of at least one active compound I and at least one active compound II for combating animal pests;
the use of a mixture of at least one active compound I and at least one active compound II for combating phytopathogenic harmful fungi;
a method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a pesticidally effective amount of a mixture of at least one active compound I and at least one active compound II;
a method for protecting crops from attack or infestation by animal pests and/or phythopathogenic harmful fungi, which comprises contacting a crop with a mixture of at least one active compound I and at least one active compound II;
a method for the protection of seeds from soil insects and of the seedlings' roots and shoots from soil and foliar insects and/or phythopathogenic harmful fungi comprising contacting the seeds before sowing and/or after pregermination with a mixture of at least one active compound I and at least one active compound II;
   and
seeds comprising a mixture of at least one active compound I and at least one active compound II.

### Compounds I

The DE 19547475 describes 3-(2,4-dioxo-pyrimidin-3-yl)-6-cyano-phenyl sulfide derivatives and their applications for protecting crops against harmful insects and weeds. The U.S. Pat. No. 6,509,354 describes 3-(4-oxo-pyrimidin-3-yl)-phenyl sulfide derivatives and their activities against various insect and mite pests. The U.S. Pat. No. 3,755,581 A describes aryl quinazolones and their applications for protecting crops against phytopathogenic bacteria and fungi, insects and gastropods. The EP 1076053 A1 describes aryl phenyl sulphide derivatives and their applications for protecting crops against insects and mites. Pesticidal active arylquinazolinone compounds have been e.g. described in WO2010/100189.

The prior art does not disclose agricultural mixtures comprising selective arylquinazolinone compounds according to the present invention in combination with other agriculturally active compounds showing unexpected and synergistic effects with regard to fungicidal and/or insecticidal activity.

The organic moieties of compounds I mentioned in the above definitions of the variables are—like the term halogen—collective terms for individual listings of the individual group members. The prefix Cₙ-Cₘ indicates in each case the possible number of carbon atoms in the group.

The term halogen denotes in each case fluorine, bromine, chlorine or iodine, in particular fluorine, chlorine or bromine.

The term “C₁-C₄-alkyl” as used herein and in the alkyl moieties of alkoxy, alkoxyalkyl, alkylthio, alkylsulfinyl, alkylsulfonyl and the like refers to saturated straight-chain or branched hydrocarbon radicals having 1, 2, 3 or 4 carbon atoms. C₁-C₂-Alkyl is methyl or ethyl. C₁-C₄-Alkyl is additionally also, for example, propyl, isopropyl, butyl, 1 methylpropyl (sec-butyl), 2-methylpropyl (isobutyl) or 1,1-dimethylethyl (tert-butyl).

The term “C₁-C₄-haloalkyl” as used herein and in the haloalkyl moieties of haloalkoxy, haloalkylthio, haloalkylsulfinyl, haloalkylsulfonyl and the like refers to straight-chain or branched alkyl groups having 1, 2, 3 or 4 carbon atoms (as mentioned above), where some or all of the hydrogen atoms in these groups may be replaced by halogen atoms as mentioned above: in particular C₁-C₄-haloalkyl, such as chloromethyl, bromomethyl, dichloromethyl, trichloromethyl, fluoromethyl, difluoro-methyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2 difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 2,2,3,3-tetrafluoropropyl, 3,3-difluoropropyl, 2,3,3-trifluoropropyl, 2,2,3,3,3-pentafluoropropyl, 4,4-difluorobutyl, 4,4,4-trifluorobutyl, 3,4,4-trifluorobutyl, 3,3,4,4-tetrafluorobutyl, 3,3,4,4,4-pentafluorobutyl or 1,1,1-trifluoroprop-2-yl.

The term “C₁-C₄-fluoroalkyl” or “fluorinated C₁-C₄-alkyl” as used herein refers to straight-chain or branched alkyl groups having 1 to 4 carbon atoms (as mentioned above), where some or all of the hydrogen atoms in these groups may be replaced by fluorine atoms: examples include fluoromethyl, difluoromethyl, trifluoromethyl, 1-fluoroethyl, 2-fluoroethyl, 2,2 difluoroethyl, 2,2,2-trifluoroethyl, pentafluoroethyl, 2,2,3,3-tetrafluoropropyl, 3,3-difluoropropyl, 2,3,3-trifluoropropyl, 2,2,3,3,3-pentafluoropropyl, 4,4-difluorobutyl, 4,4,4-trifluorobutyl, 3,4,4-trifluorobutyl, 3,3,4,4-tetrafluorobutyl, 3,3,4,4,4-pentafluorobutyl and 1,1,1-trifluoroprop-2-yl.

The term “C₂-C₄-alkenyl” as used herein and in the alkenyl moiety of alkenyloxy and the like refers to monounsaturated straight-chain or branched hydrocarbon radicals having 2 to 4 carbon atoms and a double bond in any position, for example such as ethenyl, 1-propenyl, 2-propenyl, 1-methylethenyl, 1 butenyl, 2-butenyl, 3-butenyl, 1-methyl-1-propenyl, 2-methyl-1-propenyl, 1-methyl-2-propenyl, 2-methyl-2-propenyl and the like.

The term “C₂-C₄-haloalkenyl” as used herein and the haloalkenyl moieties in haloalkenyloxy, haloalkenylcarbonyl and the like refers to unsaturated straight-chain or branched hydrocarbon radicals having 2 to 4 carbon atoms and a double bond in any position (as mentioned above), where some or all of the hydrogen atoms in these groups may be replaced by halogen atoms as mentioned above, in particular fluorine, chlorine and bromine, for example 2-chlorovinyl, 2-chloroallyl(2-chloro-2-propen-1-yl), 3-chloro-2-propen-1-yl, 3,3-dichloro-2-propen-1-yl, 2-fluorovinyl, 2,2-fluorovinyl, 3,3-difluoro-2-propen-1-yl, 2,3,3-trifluoro-2-propen-1-yl, 4,4-difluoro-3-buten-1-yl, 3,4,4-trifluoro-3-buten-1-yl and the like.

The term “C₂-C₄-fluoroalkenyl” or “fluorinated C₂-C₄-alkenyl” as used herein refers to straight-chain or branched alkenyl groups having 2 to 4 carbon atoms (as mentioned above), where some or all of the hydrogen atoms in these groups may be replaced by fluorine atoms; examples include: 2-fluorovinyl, 2,2-fluorovinyl, 3,3-difluoro-2-propen-1-yl, 2,3,3-trifluoro-2-propen-1-yl, 4,4-difluoro-3-buten-1-yl and 3,4,4-trifluoro-3-buten-1-yl.

The term “C₂-C₄-alkynyl” as used herein and the alkynyl moieties in alkynyloxy, alkynylcarbonyl and the like refers to straight-chain or branched hydrocarbon groups having 2 to 4 carbon atoms and one triple bonds in any position such as ethynyl, 1 propynyl, 2-propynyl, 1-butynyl, 2-butynyl, 3-butynyl, 1 methyl-2-propynyl, and the like;

The term “C₂-C₄-haloalkynyl” as used herein and the haloalkynyl moieties in haloalkynyloxy, haloalkynylcarbonyl and the like refers to unsaturated straight-chain or branched hydrocarbon radicals having 3 to 4 carbon atoms and one bonds in any position (as mentioned above), where some or all of the hydrogen atoms in these groups may be replaced by halogen atoms as mentioned above, in particular fluorine, chlorine and bromine;

The term “C₁-C₄-alkoxy” as used herein and in the alkoxy moieties of alkoxyalkyl refers to saturated straight-chain or branched hydrocarbon radicals having 1 to 4 carbon atoms which are bound to the remainder of the molecule via an oxygen atom. C₁-C₂-Alkoxy is methoxy or ethoxy. C₁-C₄-Alkoxy is additionally also, for example, propoxy, isopropoxy, butoxy, 1 methylpropoxy (sec-butoxy), 2-methylpropoxy (isobutoxy) or 1,1-dimethylethoxy (tert-butoxy).

The term “C₁-C₄-alkylthio” as used herein refers alkyl radicals as defined above having 1 to 4 carbon atoms which are bound to the remainder of the molecule via a sulphur atom; examples being methylthio, ethylthio, n-propylthio, isopropylthio, n-butylthio and tert.-butylthio.

The term “C₁-C₄-alkylsulfonyl” as used herein refers alkyl radicals as defined above having 1 to 4 carbon atoms which are bound to the remainder of the molecule via a S(O)2 group; examples being methylsulfonyl, ethylsulfonyl, n-propylsulfonyl, isopropyl-sulfonyl, n-butylsulfonyl and tert.-butylsulfonyl.

The term “C₁-C₄-alkylsulfinyl” as used herein refers alkyl radicals as defined above having 1 to 4 carbon atoms which are bound to the remainder of the molecule via a S(O) group; examples being methylsulfinyl, ethylsulfinyl, n-propylsulfinyl, isopropyl-sulfinyl, n-butylsulfinyl and tert.-butylsulfinyl.

The term “C₁-C₄-haloalkoxy” as used herein refers haloalkyl radicals as defined above having 1 to 4 carbon atoms which are bound to the remainder of the molecule via an oxygen atom groups having 1 to 4 carbon atoms (as mentioned above), where some or all of the hydrogen atoms in these groups may be replaced by fluorine atoms: examples include fluoromethoxy, difluoromethoxy, trifluoromethoxy, 1-fluoroethoxy, 2-fluoroethoxy, 2,2 difluoroethoxy, 2,2,2-trifluoroethoxy, 2-chloro-2-fluoroethoxy, 2-chloro-2,2-difluoroethoxy, pentafluoroethoxy, 2,2,3,3-tetrafluoropropoxy, 3,3-difluoropropoxy, 2,3,3-trifluoropropoxy, 2,2,3,3,3-pentafluoropropoxy, 4,4-difluorobutoxy, 4,4,4-trifluorobutoxy, 3,4,4-trifluorobutoxy, 3,3,4,4-tetrafluorobutoxy, 3,3,4,4,4-pentafluorobutoxy and 1,1,1-trifluoroprop-2-yloxy.

The term “C₁-C₄-haloalkylthio” as used herein refers haloalkyl radicals as defined above having 1 to 4 carbon atoms which are bound to the remainder of the molecule via a sulphur atom: examples include fluoromethylthio, difluoromethylthio, trifluoromethylthio, 1-fluoroethylthio, 2-fluoroethylthio, 2,2 difluoroethylthio, 2,2,2-trifluoroethylthio, 2-chloro-2-fluoroethylthio, 2-chloro-2,2-difluoroethylthio, pentafluoroethylthio, 2,2,3,3-tetrafluoropropylthio, 3,3-difluoropropylthio, 2,3,3-trifluoropropylthio, 2,2,3,3,3-pentafluoropropylthio, 4,4-difluorobutylthio, 4,4,4-trifluorobutylthio, 3,4,4-trifluorobutylthio, 3,3,4,4-tetrafluorobutylthio, 3,3,4,4,4-pentafluorobutylthio and 1,1,1-trifluoroprop-2-ylthio.

The term “C₁-C₄-haloalkylsulfonyl” as used herein refers haloalkyl radicals as defined above having 1 to 4 carbon atoms which are bound to the remainder of the molecule via a S(O)2 group; examples include fluoromethylsulfonyl, difluoromethylsulfonyl, trifluoromethylsulfonyl, 1-fluoroethylsulfonyl, 2-fluoroethylsulfonyl, 2,2 difluoroethylsulfonyl, 2,2,2-trifluoroethylsulfonyl, pentafluoroethylsulfonyl, 2,2,3,3-tetrafluoropropylsulfonyl, 3,3-difluoropropylsulfonyl, 2,3,3-trifluoropropylsulfonyl, 2,2,3,3,3-pentafluoropropylsulfonyl, 4,4-difluorobutylsulfonyl, 4,4,4-trifluorobutylsulfonyl, 3,4,4-trifluorobutylsulfonyl, 3,3,4,4-tetrafluorobutylsulfonyl, 3,3,4,4,4-pentafluorobutylsulfonyl and 1,1,1-trifluoroprop-2-ylsulfonyl.

The term “C₁-C₄-haloalkylsulfinyl” as used herein refers haloalkyl radicals as defined above having 1 to 4 carbon atoms which are bound to the remainder of the molecule via a S(O) group; examples include fluoromethylsulfinyl, difluoromethylsulfinyl, trifluoromethylsulfinyl, 1-fluoroethylsulfinyl, 2-fluoroethylsulfinyl, 2,2 difluoroethylsulfinyl, 2,2,2-trifluoroethylsulfinyl, pentafluoroethylsulfinyl, 2,2,3,3-tetrafluoropropylsulfinyl, 3,3-difluoropropylsulfinyl, 2,3,3-trifluoropropylsulfinyl, 2,2,3,3,3-pentafluoropropylsulfinyl, 4,4-difluorobutylsulfinyl, 4,4,4-trifluorobutylsulfinyl, 3,4,4-trifluorobutylsulfinyl, 3,3,4,4-tetrafluorobutylsulfinyl, 3,3,4,4,4-pentafluorobutylsulfinyl and 1,1,1-trifluoroprop-2-ylsulfinyl.

The term “C₁-C₄-alkoxy-C₁-C₄-alkyl” as used herein refers to a linear or branched C₁-C₄-alkyl radical as defined above, which is substituted by an C₁-C₄-alkoxy radical, in particular to methoxymethyl, ethoxymethyl, n-propoxymethyl, n-butoxyethyl, 2-methoxyethyl, 2-ethoxyethyl, 2-(n-propoxy)ethyl, 2-(n-butoxy)ethyl, 2-methoxypropyl, 2-ethoxypropyl, 2-(n-propoxy)propyl, 2-(n-butoxy)propyl, 3-methoxypropyl, 3-ethoxypropyl, 3-(n-propoxy)propyl, 3-(n-butoxy)propyl, 4-methoxybutyl and 4-ethoxybutyl.

The remarks made further below concerning preferred embodiments of the variables of the compounds of formula I, of the features of the use and method according to the invention and of the composition of the invention are valid on their own as well as preferably in combination with each other.

The compounds I of formula (I) and their examples include their tautomers, racemic mixtures, individual pure enantiomers and diastereomers and their optically active mixtures.

### Compounds II

The active compounds II mentioned above of groups F.I to F.XI, their preparation and their action against harmful fungi are generally known (cf., for example, http://www.hclrss.demon.co.uk/index.html); they are commercially available. Benalaxyl, methyl N-(phenylacetyl)-N-(2,6-xylyl)-DL-alaninate (DE 29 03 612); metalaxyl, methyl N-(methoxyacetyl)-N-(2,6-xylyl)-DL-alaninate (GB 15 00 581); ofurace, (RS)-α-(2-chloro-N-2,6-xylylacetamido)-γ-butyrolactone [CAS RN 58810-48-3]; oxadixyl; N-(2,6-dimethylphenyl)-2-methoxy-N-(2-oxo-3-oxazolidinyl)acetamide (GB 20 58 059); aldimorph, “4-alkyl-2,5(or 2,6)-dimethylmorpholine”, comprising 65-75% of 2,6-dimethylmorpholine and 25-35% of 2,5-dimethylmorpholine, comprising more than 85% of 4-dodecyl-2,5(or 2,6)-dimethylmorpholine, where “alkyl” also includes octyl, decyl, tetradecyl and hexadecyl, with a cis/trans ratio of 1:1 [CAS RN 91315-15-0]; dodine, 1-dodecylguanidinium acetate (Plant Dis. Rep., Vol. 41, p. 1029 (1957)); dodemorph, 4-cyclododecyl-2,6-dimethylmorpholine (DE-A 11 98 125); fenpropimorph, (RS)-cis-4-[3-(4-tert-butylphenyl)-2-methylpropyl]-2,6-dimethylmorpholine (DE-A 27 52 096); fenpropidin, (RS)-1-[3-(4-tert-butylphenyl)-2-methylpropyl]piperidine (DE-A 27 52 096); guazatine, mixture of the reaction products from the amidation of technical grade iminodi(octamethylene)diamine, comprising various guanidines and polyamines [CAS RN 108173-90-6]; iminoctadine, 1,1′-iminodi(octamethylene)diguanidine (Congr. Plant Pathol., 1., p. 27 (1968); spiroxamine, (8-tert-butyl-1,4-dioxaspiro[4.5]dec-2-yl)diethylamine (EP-A 281 842); tridemorph, 2,6-dimethyl-4-tridecylmorpholine (DE-A 11 64 152); pyrimethanil, 4,6-dimethylpyrimidin-2-ylphenylamine (DD-A 151 404); mepanipyrim, (4-methyl-6-prop-1-ynylpyrimidin-2-yl)phenylamine (EP-A 224 339); cyprodinil, (4-cyclopropyl-6-methylpyrimidin-2-yl)phenylamine (EP-A 310 550); cycloheximide, 4-{(2R)-2-[(1S,3S,5S)-3,5-dimethyl-2-oxocyclohexyl]-2-hydroxyethyl}piperidine-2,6-dione [CAS RN 66-81-9]; griseofulvin, 7-chloro-2′,4,6-trimethoxy-6′-methylspiro[benzofuran-2(3H),1′-cyclohex-2′-ene]-3,4′-dione [CAS RN 126-07-8]; kasugamycin, 3-O-[2-amino-4-[(carboxylminomethyl)amino]-2,3,4,6-tetradeoxy-α-D-arabino-hexopyranosyl]-D-chiro-inositol [CAS RN 6980-18-3]; natamycin, (8E,14E,16E,18E,20E)-(1R,3S,5R,7R,12R,22R,24S,25R,26S)-22-(3-amino-3,6-dideoxyl-β-D-mannopyranosyloxy)-1,3,26-trihydroxy-12-methyl-10-oxo-6,11,28-trioxatricyclo[22.3.1.0^{5,7}]octacosa-8,14,16,18,20-pentaene-25-carboxylic acid [CAS RN 7681-93-8]; polyoxin, 5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid [CAS RN 22976-86-9]; streptomycin, 1,1′-{1-L-(1,3,5/2,4,6)-4-[5-deoxy-2-O-(2-deoxy-2-methylamino-α-L-glucopyranosyl)-3-C-formyl-α-L-Iyxofuranosyloxy]-2,5,6-trihydroxycyclohex-1,3-ylene}diguanidine (J. Am. Chem. Soc. Vol. 69, p. 1234 (1947)); bitertanol, β-([1,1′-biphenyl]-4-yloxy)-α-(1,1-dimethylethyl)-1H-1,2,4-triazole-1-ethanol (DE-A 23 24 020); bromuconazole, 1-[[4-bromo-2-(2,4-dichlorophenyl)tetrahydro-2-furanyl]methyl]-1H-1,2,4-triazole (Proc. 1990 Br. Crop. Prot. Conf.—Pests Dis. Vol. 1, p. 459); cyproconazole, 2-(4-chlorophenyl)-3-cyclopropyl-1-[1,2,4]triazol-1-ylbutan-2-ol (U.S. Pat. No. 4,664,696); difenoconazole, 1-{2-[2-chloro-4-(4-chlorophenoxy)phenyl]-4-methyl-[1,3]dioxolan-2-ylmethyl}-1H-[1,2,4]triazole (GB-A 2 098 607); diniconazole, (β E)-β-[(2,4-dichlorophenyl)methylene]-α-(1,1-dimethylethyl)-1H-1,2,4-triazole-1-ethanol (Noyaku Kagaku, 1983, Vol. 8, p. 575); enilconazole (imazalil), 1-[2-(2,4-dichlorophenyl)-2-(2-propenyloxy)ethyl]-1H-imidazole (Fruits, 1973, Vol. 28, p. 545); epoxiconazole, (2RS,3SR)-1-[3-(2-chlorophenyl)-2,3-epoxy-2-(4-fluorophenyl)propyl]-1H-1,2,4-triazole (EP-A 196 038); fenbuconazole, α-[2-(4-chlorophenyl)ethyl]-α-phenyl-1H-1,2,4-triazole-1-propanenitrile (Proc. 1988 Br. Crop Prot. Conf.—Pests Dis., Vol. 1, p. 33); fluquinconazole, 3-(2,4-dichlorophenyl)-6-fluoro-2-[1,2,4]-triazol-1-yl-3H-quinazolin-4-one (Proc. Br. Crop Prot. Conf.—Pests Dis., 5-3, 411 (1992)); flusilazole, 1-{[bis(4-fluorophenyl)methylsilanyl]methyl}-1H-[1,2,4]triazole (Proc. Br. Crop Prot. Conf.—Pests Dis., Vol. 1, p. 413 (1984)); flutriafol, α-(2-fluorophenyl)-α-(4-fluorophenyl)-1H-1,2,4-triazole-1-ethanol (EP-A 15 756); hexaconazole, 2-(2,4-dichlorophenyl)-1-[1,2,4]triazol-1-ylhexan-2-ol (CAS RN 79983-71-4); ipconazole, 2-[(4-chlorophenyl)methyl]-5-(1-methylethyl)-1-(1H-1,2,4-triazol-1-ylmethyl)cyclopentanol (EP-A 267 778); metconazole, 5-(4-chlorobenzyl)-2,2-dimethyl-1-[1,2,4]triazol-1-ylmethylcyclopentanol (GB 857 383); myclobutanil, 2-(4-chlorophenyl)-2-[1,2,4]triazol-1-ylmethylpentanenitrile (CAS RN 88671-89-0); penconazole, 1-[2-(2,4-dichlorophenyl)pentyl]-1H-[1,2,4]triazole (Pesticide Manual, 12th Ed. 2000, p. 712); propiconazole, 1-[[2-(2,4-dichlorophenyl)-4-propyl-1,3-dioxolan-2-yl]methyl]-1H-1,2,4-triazole (BE 835 579); prochloraz, N-(propyl-[2-(2,4,6-trichlorophenoxy)ethyl])imidazole-1-carboxamide (U.S. Pat. No. 3,991,071); prothioconazole, 2-[2-(1-chlorocyclopropyl)-3-(2-chlorophenyl)-2-hydroxypropyl]-2,4-dihydro[1,2,4]triazole-3-thione (WO 96/16048); simeconazole, α-(4-fluorophenyl)-α-[(trimethylsilyl)methyl]-1H-1,2,4-triazole-1-ethanol [CAS RN 149508-90-7], tebuconazole, 1-(4-chlorophenyl)-4,4-dimethyl-3-[1,2,4]triazol-1-ylmethylpentan-3-ol (EP-A 40 345); tetraconazole, 1-[2-(2,4-dichlorophenyl)-3-(1,1,2,2-tetrafluoroethoxy)propyl]-1H-1,2,4-triazole (EP-A 234 242); triadimefon, 1-(4-chlorophenoxy)-3,3-dimethyl-1-(1H-1,2,4-triazol-1-yl)-2-butanone (BE 793 867); triadimenol, β-(4-chlorophenoxy)-α-(1,1-dimethylethyl)-1H-1,2,4-triazole-1-ethanol (DE-A 3 24 010); triflumizol, (4-chloro-2-trifluoromethylphenyl)-(2-propoxy-1-[1,2,4]triazol-1-ylethylidene)-amine (JP-A 79/119 462); triticonazole, (5E)-5-[(4-chlorophenyl)methylene]-2,2-dimethyl-1-(1H-1,2,4-triazol-1-ylmethyl)cyclopentanol (FR 26 41 277); iprodione, N-isopropyl-3-(3,5-dichlorophenyl)-2,4-dioxoimidazolidine-1-carboxamide (GB 13 12 536); myclozolin, (RS)-3-(3,5-dichlorophenyl)-5-methoxymethyl-5-methyl-1,3-oxazolidine-2,4-dione [CAS RN 54864-61-8]; procymidone, N-(3,5-dichlorophenyl)-1,2-dimethylcyclopropane-1,2-dicarboximide (U.S. Pat. No. 3,903,090); vinclozolin, 3-(3,5-dichlorophenyl)-5-methyl-5-vinyloxazolidine-2,4-dione (DE-A 22 07 576); ferbam, iron(3+) dimethyldithiocarbamate (U.S. Pat. No. 1,972,961); nabam, disodium ethylenebis(dithiocarbamate) (U.S. Pat. No. 2,317,765); maneb, manganese ethylenebis(dithiocarbamate) (U.S. Pat. No. 2,504,404); mancozeb, manganese ethylenebis(dithiocarbamate) polymer complex zinc salt (GB 996 264); metam, methyldithiocarbaminic acid (U.S. Pat. No. 2,791,605); metiram, zinc ammoniate ethyllenebis(dithiocarbamate) (U.S. Pat. No. 3,248,400); propineb, zinc propylenebis(dithiocarbamate) polymer (BE 611 960); polycarbamate, bis(dimethylcarbamodithioato-κS,κS)[μ-[[1,2-ethanediylbis[carbamodithioato-κS,κS]](2-)]]di[zinc] [CAS RN 64440-88-6]; thiram, bis(dimethylthiocarbamoyl)disulfide (DE-A 642 532); ziram, dimethyldithiocarbamate [CAS RN 137-30-4]; zineb, zinc ethylenebis(dithiocarbamate) (U.S. Pat. No. 2,457,674); anilazine, 4,6-dichloro-N-(2-chlorophenyl)-1,3,5-triazine-2-amine (U.S. Pat. No. 2,720,480); benomyl, N-butyl-2-acetylaminobenzimidazole-1-carboxamide (U.S. Pat. No. 3,631,176); boscalid, 2-chloro-N-(4′-chlorobiphenyl-2-yl)nicotinamide (EP-A 545 099); carbendazim, methyl (1H-benzimidazol-2-yl)carbamate (U.S. Pat. No. 3,657,443); carboxin, 5,6-dihydro-2-methyl-N-phenyl-1,4-oxathiine-3-carboxamide (U.S. Pat. No. 3,249,499); oxycarboxin, 5,6-dihydro-2-methyl-1,4-oxathiine-3-carboxanilide 4,4-dioxide (U.S. Pat. No. 3,399,214); cyazofamid, 4-chloro-2-cyano-N,N-dimethyl-5-(4-methylphenyl)-1H-imidazole-1-sulfonamide (CAS RN 120116-88-3]; dazomet, 3,5-dimethyl-1,3,5-thiadiazinane-2-thione (Bull. Soc. Chim. Fr. Vol. 15, p. 891 (1897)); diflufenzopyr, 2-{1-[4-(3,5-difluorophenyl)semicarbazono]ethyl}nicotinic acid [CAS RN 109293-97-2]; dithianon, 5,10-dioxo-5,10-dihydronaphtho[2,3-b][1,4]dithiin-2,3-dicarbonitrile (GB 857 383); famoxadone, (RS)-3-anilino-5-methyl-5-(4-phenoxyphenyl)-1,3-oxazolidine-2,4-dione [CAS RN 131807-57-3]; fenamidone, (S)-1-anilino-4-methyl-2-methylthio-4-phenylimidazolin-5-one [CAS RN 161326-34-7]; fenarimol, α-(2-chlorophenyl)-α-(4-chlorophenyl)-5-pyrimidinemethanol (GB 12 18 623); fuberidazole, 2-(2-furanyl)-1H-benzimidazole (DE-A 12 09 799); flutolanil, α,α,α-trifluoro-3′-isopropoxy-o-toluanilide (JP 1104514); furametpyr, 5-chloro-N-(1,3-dihydro-1,1,3-trimethyl-4-isobenzofuranyl)-1,3-dimethyl-1H-pyrazole-4-carboxamide [CAS RN 123572-88-3]; isoprothiolane, diisopropyl 1,3-dithiolan-2-ylidenemalonate (Proc. Insectic. Fungic. Conf. 8. Vol. 2, p. 715 (1975)); mepronil, 3′-isopropoxy-o-toluanilide (U.S. Pat. No. 3,937,840); nuarimol, α-(2-chlorophenyl)-α-(4-fluorophenyl)-5-pyrimidinemethanol (GB 12 18 623); fluopicolide (picobenzamid), 2,6-dichloro-N-(3-chloro-5-trifluoromethylpyridin-2-ylmethyl)benzamide (WO 99/42447); probenazole, 3-allyloxy-1,2-benzothiazole 1,1-dioxide (Agric. Biol. Chem. Vol. 37, p. 737 (1973)); proquinazid, 6-iodo-2-propoxy-3-propylquinazolin-4(3H)-one (WO 97/48684); pyrifenox, 2′,4′-dichloro-2-(3-pyridyl)acetophenone (EZ)-O-amethyloxime (EP 49 854); pyroquilon, 1,2,5,6-tetrahydropyrrolo[3,2,1-ij]quinolin-4-one (GB 139 43 373); quinoxyfen, 5,7-dichloro-4-(4-fluorophenoxy)quinoline (U.S. Pat. No. 5,240,940); silthiofam, N-allyl-4,5-dimethyl-2-(trimethylsilyl)thiophene-3-carboxamide [CAS RN 175217-20-6]; thiabendazole, 2-(1,3-thiazol-4-yl)benzimidazole (U.S. Pat. No. 3,017,415); thifluzamide, 2′,6′-dibromo-2-methyl-4′-trifluoromethoxy-4-trifluoromethyl-1,3-thiazole-5-carboxanilide [CAS RN 130000-40-7]; thiophanate-methyl, 1,2-phenylenebis(iminocarbonothioyl)bis(dimethylcarbamate) (DE-A 19 30 540); tiadinil, 3′-chloro-4,4′-dimethyl-1,2,3-thiadiazole-5-carboxanilide [CAS RN 223580-51-6]; tricyclazole, 5-methyl-1,2,4-triazolo[3,4-b][1,3]benzothiazole [CAS RN 41814-78-2]; triforine, N,N-{piperazine-1,4-diylbis[(trichloromethyl)methyllene]}diformamide (DE-A 19 01 421); 5-chloro-7-(4-methylpiperidin-1-yl)-6-(2,4,6-trifluorophenyl)-[1,2,4]triazolo[1,5-a]pyrimidine (WO 98/46607) and other triazolo pyrimidine (EP-A 71 792; EP-A 141 317; WO 2003/009687; WO 2005/087771; WO 2005/087772; WO 2005/087773; WO 2006/087325; WO 2006/092428); Bordeaux mixture, mixture of CuSO₄×3Cu(OH)₂×3CaSO₄ [CAS RN 8011-63-0]; copper acetate, Cu(OCOCH₃)₂ [CAS RN 8011-63-0]; copper oxychloride, Cu₂Cl(OH)₃ [CAS RN 1332-40-7]; basic copper sulfate, CuSO₄ [CAS RN 1344-73-6]; binapacryl, (RS)-2-sec-butyl-4,6-dinitrophenyl 3-methylcrotonate [CAS RN 485-31-4]; dinocap, mixture of 2,6-dinitro-4-octylphenylcrotonate and 2,4-dinitro-6-octylphenylcrotonate, where “octyl” is a mixture of 1-methylheptyl, 1-ethylhexyl and 1-propylpentyl (U.S. Pat. No. 2,526,660); dinobuton, (RS)-2-sec-butyl-4,6-dinitrophenyl isopropyl carbonate [CAS RN 973-21-7]; nitrothal-isopropyl, diisopropyl 5-nitroisophthalate (Proc. Br. Insectic. Fungic. Conf. 7., Vol. 2, p. 673 (1973)); fenpiclonil, 4-(2,3-dichlorophenyl)-1H-pyrrole-3-carbonitrile (Proc. 1988 Br. Crop Prot. Conf.—Pests Dis., Vol. 1, p. 65); fludioxonil, 4-(2,2-difluorobenzo[1,3]dioxol-4-yl)-1H-pyrrole-3-carbonitrile (The Pesticide Manual, publ. The British Crop Protection Council, 10th ed. 1995, p. 482); acibenzolar-S-methyl, methyl 1,2,3-benzothiadiazole-7-carbothioate [CAS RN 135158-54-2]; flubenthiavalicarb (benthiavalicarb), isopropyl {(S)-1-[(1R)-1-(6-fluorobenzothiazol-2-yl)-ethylcarbamoyl]-2-methylpropyl}carbamate (JP-A 09/323,984); carpropamid, 2,2-dichloro-N-[1-(4-chlorophenyl)ethyl]-1-ethyl-3-methylcyclopropane-carboxamide [CAS RN 104030-54-8]; chlorothalonil, 2,4,5,6-tetrachloroisophthalonitrile (U.S. Pat. No. 3,290,353); cyflufenamid, (Z)-N-[α-(cyclopropylmethoxyimino)-2,3-difluoro-6-(trifluoromethyl)benzyl]-2-phenylacetamide (WO 96/19442); cymoxanil, 1-(2-cyano-2-methoxyiminoacetyl)-3-ethylurea (U.S. Pat. No. 3,957,847); diclomezine, 6-(3,5-dichlorophenyl-p-tolyl)pyridazin-3(2H)-one (U.S. Pat. No. 4,052,395;) diclocymet, (RS)-2-cyano-N-[(R)-1-(2,4-dichlorophenyl)ethyl]-3,3-dimethylbutyramide [CAS RN 139920-32-4]; diethofencarb, isopropyl 3,4-diethoxycarbanilate (EP-A 78 663); edifenphos, O-ethyl S,S-diphenyl phosphorodithioate (DE-A 14 93 736); ethaboxam, (cyano-2-thienylmethyl)-4-ethyl-2-(ethylamino)-5-thiazolecarboxamide (EP-A 639 574); fenhexamid, N-(2,3-dichloro-4-hydroxyphenyl)-1-methylcyclohexanecarboxamide (Proc. Br. Crop Prot. Conf.—Pests Dis., 1998, Vol. 2, p. 327); fentin-acetate, triphenyltin (U.S. Pat. No. 3,499,086); fenoxanil, N-(1-cyano-1,2-dimethylpropyl)-2-(2,4-dichlorophenoxy)propanamide (EP-A 262 393); ferimzone, (Z)-2′-methylacetophenone-4,6-dimethylpyrimidin-2-ylhydrazone [CAS RN 89269-64-7]; fluazinam, 3-chloro-N-[3-chloro-2,6-dinitro-4-(trifluoromethyl)phenyl]-5-(trifluoromethyl)-2-pyridinamine (The Pesticide Manual, publ. The British Crop Protection Council, 10th ed. (1995), p. 474); fosetyl, fosetyl-aluminum, ethylphosphonate (FR 22 54 276); iprovalicarb, isopropyl [(1S)-2-methyl-1-(1-p-tolylethylcarbamoyl)propyl]carbamate (EP-A 472 996); hexachlorobenzene (C. R. Seances Acad. Agric. Fr., Vol. 31, p. 24 (1945)); mandipropamid, (RS)-2-(4-chlorophenyl)-N-[3-methoxy-4-(prop-2-ynyloxy)phenethyl]-2-(prop-2-ynyloxy)acetamide (WO 03/042166); metrafenone, 3′-bromo-2,3,4,6′-tetramethoxy-2′,6-dimethylbenzophenone (U.S. Pat. No. 5,945,567); pencycuron, 1-(4-chlorobenzyl)-1-cyclopentyl-3-phenylurea (DE-A 27 32 257); penthiopyrad, (RS)—N-[2-(1,3-dimethylbutyl)-3-thienyl]-1-methyl-3-(trifluoromethyl)-1H-pyrazole-4-carboxamide (JP 10/130,268); propamocarb, isopropyl 3-(dimethylamino)propylcarbamate (DE-A 15 67 169); phthalide (DE-A 16 43 347); toloclofos-methyl, O-2,6-dichloro-p-tolyl O,O-dimethyl phosphorothioate (GB 14 67 561); quintozene, pentachloronitrobenzene (DE-A 682 048); zoxamide, (RS)-3,5-dichloro-N-(3-chloro-1-ethyl-1-methyl-2-oxopropyl)-p-toluamide [CAS RN 156052-68-5]; captafol, N-(1,1,2,2-tetrachloroethylthio)cyclohex-4-ene-1,2-dicarboximide (Phytopathology, Vol. 52, p. 754 (1962)); captan, N-(trichloromethylthio)cyclohex-4-ene-1,2-dicarboximide (U.S. Pat. No. 2,553,770); dichlofluanid, N-dichlorofluoromethylthio-N,N-dimethyl-N-phenylsulfamide (DE-A 11 93 498); folpet, N-(trichloromethylthio)phthalimide (U.S. Pat. No. 2,553,770); tolylfluanid, N-dichlorofluoromethylthio-N,N-dimethyl-N-p-tolylsulfamide (DE-A 11 93 498); dimethomorph, 3-(4-chlorophenyl)-3-(3,4-dimethoxyphenyl)-1-morpholin-4-yl-propenone (EP-A 120 321); flumetover, 2-(3,4-dimethoxyphenyl)-N-ethyl-α,α,α-trifluoro-N-methyl-p-toluamide [AGROW no. 243, 22 (1995)]; flumorph, 3-(4-fluorophenyl)-3-(3,4-dimethoxyphenyl)-1-morpholin-4-ylpropenone (EP-A 860 438); N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide (WO 03/66610); N-(3′,4′-dichloro-4-fluorobiphenyl-2-yl)-3-difluoromethyl-1-methylpyrazole-4-carboxamide and N-(3′,4′-dichloro-5-fluorobiphenyl-2-yl)-3-difluoromethyl-1-methylpyrazole-4-carboxamide (WO 03/70705); N-(2-cyanophenyl)-3,4-dichloroisothiazole-5-carboxamide (WO 99/24413); N-(2-(4-[3-(4-chlorophenyl)prop-2-ynyloxy]-3-methoxyphenyl)ethyl)-2-methanesulfonylamino-3-methylbutyramide, N-(2-(4-[3-(4-chlorophenyl)prop-2-ynyloxy]-3-methoxyphenyl)ethyl)-2-ethanesulfonylamino-3-methylbutyramide (WO 04/49804); N-(2-Bicycloprop-2-ylphenyl)-3-difluoromethyl-1-methyl-1H-pyrazole-4-carboxamide is a mixture of the diastereomers N-(trans-2-bicycloprop-2-ylphenyl)-3-difluoromethyl-1-methyl-1H-pyrazole-4-carboxamide and N-(cis-2-bicycloprop-2-ylphenyl)-3-difluoromethyl-1-methyl-1H-pyrazole-4-carboxamide (WO 03/074491 and WO 2006/015866); 3-[5-(4-chlorophenyl)-2,3-dimethylisoxazolidin-3-yl]pyridine (EP-A 10 35 122); 2-butoxy-6-iodo-3-propylchromen-4-one (WO 03/14103); N,N-dimethyl-3-(3-bromo-6-fluoro-2-methylindole-1-sulfonyl)-[1,2,4]triazole-1-sulfonamide (EP-A 10 31 571); methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate (EP-A 12 01 648); methyl 3-(4-chlorophenyl)-3-(2-isopropoxycarbonylamino-3-methylbutyrylamino)propionate (EP-A 10 28 125); azoxystrobin, methyl 2-{2-[6-(2-cyano-1-vinylpenta-1,3-dienyloxy)pyrimidin-4-yloxy]phenyl}-3-methoxyacrylate (EP-A 382 375), dimoxystrobin, (E)-2-(methoxyimino)-N-methyl-2-[α-(2,5-xylyloxy)-o-tolyl]acetamide (EP-A 477 631); fluoxastrobin, (E)-{2-[6-(2-chlorophenoxy)-5-fluoropyrimidin-4-yloxy]phenyl}(5,6-dihydro-1,4,2-dioxazin-3-yl)methanone O-methyloxime (WO 97/27189); kresoxim-methyl, methyl (E)-methoxyimino[α-(o-tolyloxy)-o-tolyl]acetate (EP-A 253 213); metominostrobin, (E)-2-(methoxyimino)-N-methyl-2-(2-phenoxyphenyl)acetamide (EP-A 398 692); orysastrobin, (2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide (WO 97/15552); picoxystrobin, methyl 3-methoxy-2-[2-(6-trifluoromethylpyridin-2-yloxymethyl)phenyl]acrylate (EP-A 278 595); pyraclostrobin, methyl N-{2-[1-(4-chlorophenyl)-1H-pyrazol-3-yloxymethyl]phenyl}(N-methoxy)carbamate (WO 96/01256); trifloxystrobin, methyl (E)-methoxyimino-{(E)-α-[1-(α,α,α-trifluoro-m-tolyl)ethylideneaminooxy]-o-tolyl}acetate (EP-A 460 575); methyl 2-[ortho-(2,5-dimethylphenyloxymethylene)phenyl]-3-methoxyacrylate (EP-A 226 917); 5-chloro-7-(4-methylpiperidin-1-yl)-6-(2,4,6-trifluorophenyl)-[1,2,4]triazolo[1,5-a]pyrimidine (WO 98/46608); 3,4-dichloro-N-(2-cyanophenyl)isothiazole-5-carboxamide (WO 99/24413), compounds of the formula III (WO 04/049804); N-(2-(4-[3-(4-chlorophenyl)prop-2-ynyloxy]-3-methoxyphenyl)ethyl)-2-methanesulfonylamino-3-methylbutyramide and N-(2-(4-[3-(4-chlorophenyl)prop-2-ynyloxy]-3-methoxyphenyl)ethyl)-2-ethanesulfonylamino-3-methylbutyramide (WO 03/66609); 2-butoxy-6-iodo-3-propylchromen-4-one (WO 03/14103); N,N-dimethyl-3-(3-bromo-6-fluoro-2-methylindole-1-sulfonyl)-[1,2,4]triazole-1-sulfonamide (WO 03/053145); methyl 3-(4-chlorophenyl)-3-(2-isopropoxycarbonylamino-3-methylbutyrylamino)-propanoate (EP-A 1028125).

### Preferences

### Preferred Compounds I of Formula I

With regard to their use in the pesticidal mixtures of the present invention, compounds I of formula I are preferred, wherein the substituents are selected as defined hereinbelow.

Preferred are compounds I of formula (I), wherein R¹ is 2,2,2-trifluoroethyl.

Preferred are compounds I of formula (I), wherein R² is selected from chlorine, methyl, difluoromethyl, trifluoromethyl or cyano.

Preferred are compounds I of formula (I), wherein R² is methyl.

Preferred are compounds I of formula (I), wherein R³ is selected from hydrogen, fluorine, chlorine, methyl or trifluoromethyl.

Preferred are compounds of formula (I), wherein R³ is fluorine.

Especially preferred are compounds I of formula (I), wherein R² is selected from chlorine, methyl, difluoromethyl, trifluoromethyl or cyano and R³ is selected from hydrogen, fluorine, chlorine, methyl or trifluoromethyl.

Especially more preferred are compounds I of formula (I), wherein R³ is fluorine and R² is methyl.

In one preferred embodiment of the compound I of formula (I) k is 0.

In another preferred embodiment of the compound I of formula (I) k is 1, 2 or 3, and R⁴ is selected independently from the integer of k from fluorine, chlorine, CN, NO₂, methyl, trifluoromethyl, methoxy difluoromethoxy or trifluoromethoxy.

Especially preferred are compounds I of formula (I-A):

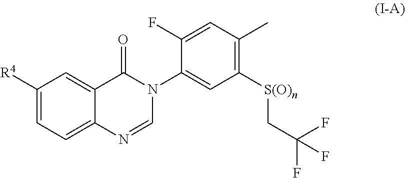

wherein R⁴ is selected from fluorine, chlorine, methyl, trifluoromethyl, methoxy, difluoromethoxy and trifluoromethoxy,
and
wherein n is 0 or 1.

Especially preferred are compounds I formula (I-A-1):

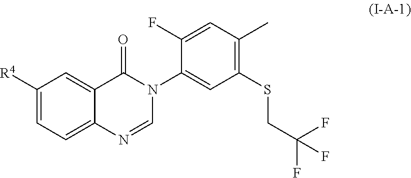

wherein R⁴ is selected from fluorine, chlorine, methyl, trifluoromethyl, methoxy, difluoromethoxy and trifluoromethoxy.

Especially preferred are compounds I formula (I-A-2):

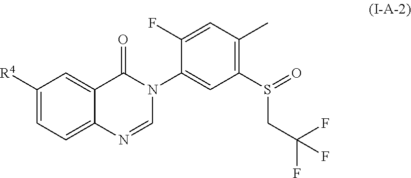

wherein R⁴ is selected from fluorine, chlorine, methyl, trifluoromethyl, methoxy, difluoromethoxy and trifluoromethoxy.

The compounds I of formula I-A-2 carry a chiral sulfoxide group, so that they form two enantiomers with R- or S-configuration at the sulphur atom:

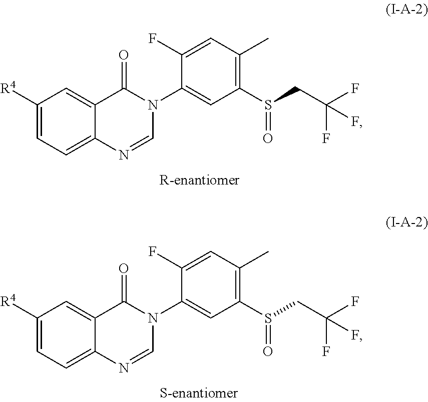

Both enantiomers as well as a mixture of both enantiomers, or a racemate are especially preferred compounds of the invention.

Especially preferred are compounds I of formula (I-B):

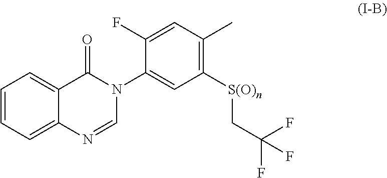

wherein n is 0 or 1.

Especially preferred is the compound I of formula (I-B-1):

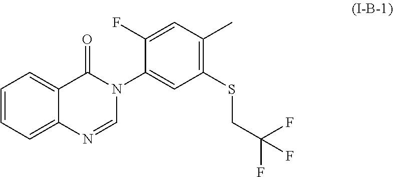 [SMILES: Cc1cc(F)c(-n2cnc3ccccc3c2=O)cc1SCC(F)(F)F]

Especially preferred is the compound I of formula (I-B-2):

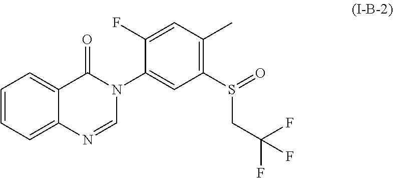 [SMILES: Cc1cc(F)c(-n2cnc3ccccc3c2=O)cc1S(=O)CC(F)(F)F]

The compound I of formula (I-B-2) carries a chiral sulfoxide group, so that it forms the following two enantiomers with R- or S-configuration at the sulphur atom:

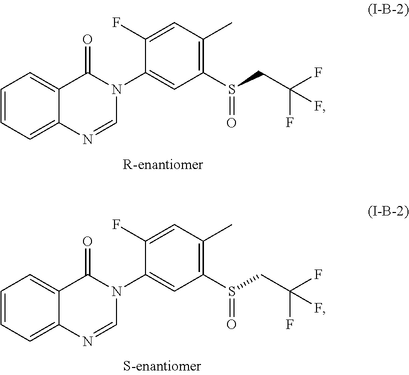 [SMILES: Cc1cc(F)c(-n2cnc3ccccc3c2=O)cc1[S@](=O)CC(F)(F)F ; Cc1cc(F)c(-n2cnc3ccccc3c2=O)cc1[S@@](=O)CC(F)(F)F]

Both enantiomers as well as a mixture of both enantiomers, or a racemate are a especially preferred compounds I of the invention.

Examples of preferred arylquinazolinone compounds I of the present invention are of the following formula (I-C)

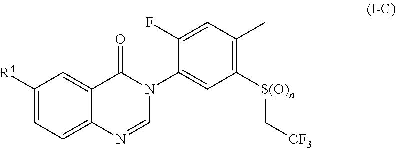

wherein R⁴ is selected from fluorine, chlorine, methyl, trifluoromethyl, methoxy, difluoromethoxy and trifluoromethoxy, and wherein n is 0 or 1.

Further especially preferred compounds of the present invention are the one of formula (I-C-1):

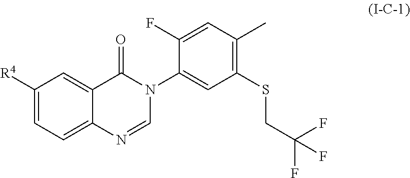

wherein R⁴ is selected from fluorine, chlorine, methyl, trifluoromethyl, methoxy, difluoromethoxy and trifluoromethoxy.

Further especially preferred compounds of the present invention are the one of formula (I-C-2):

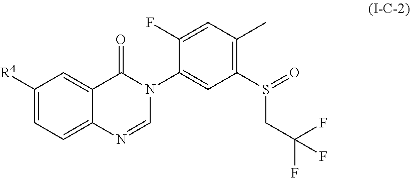

wherein R⁴ is selected from fluorine, chlorine, methyl, trifluoromethyl, methoxy, difluoromethoxy and trifluoromethoxy.

The compounds of formula I-C-2 carry a chiral sulfoxide group, so that they form two enantiomers with R- or S-configuration at the sulphur atom:

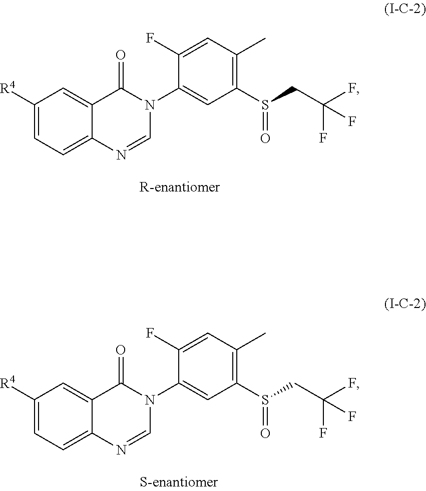

Both enantiomers as well as a mixture of both enantiomers, or a racemate are especially preferred compounds of the invention.

Examples of especially preferred arylquinazolinone compounds I of the present invention are of formula (I-C)

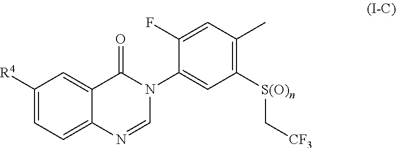

wherein R⁴ and n are defined in one row of table C.I.1

TABLE C.I.1

| Comp. C.I | n | R⁴ |
|---|---|---|
| C.I-1 | 0 | H |
| C.I-2 | 0 | CH₃ |
| C.I-3 | 0 | CF₃ |
| C.I-4 | 0 | F |
| C.I-5 | 0 | Cl |
| C.I-6 | 0 | Br |
| C.I-7 | 0 | CN |
| C.I-8 | 0 | OCH₃ |
| C.I-9 | 0 | OCHF₂ |
| C.I-10 | 0 | OCF₃ |
| C.I-11 | 1 | H |
| C.I-12 | 1 | CH₃ |
| C.I-13 | 1 | CF₃ |
| C.I-14 | 1 | F |
| C.I-15 | 1 | Cl |
| C.I-16 | 1 | Br |
| C.I-17 | 1 | CN |
| C.I-18 | 1 | OCH₃ |
| C.I-19 | 1 | OCHF₂ |
| C.I-20 | 1 | OCF₃ |

General Preparation Methods of Compounds of Formula I

Preparation of the compounds of formula I can be accomplished according to standard methods of organic chemistry, e.g. by the methods or working examples described in WO 2010/100189 without being limited to the routes given therein.

Preferred active compounds II selected from group F

With respect to their use in the pesticidal mixtures of the present invention, particular preference is given to the compounds C.II as listed in the paragraphs below.

With regard to the use in a pesticidal mixture of the present invention, the compound II selected from group F.Ia).

More preferably the compound II is azoxystrobin, fluoxastrobin, picoxystrobin, pyraclostrobin or trifloxystrobin.

With regard to the use in a pesticidal mixture of the present invention, the compound II selected from group F.Ib).

More preferably the compound II is cyazofamid.

With regard to the use in a pesticidal mixture of the present invention, the compound II selected from group F.Ic).

More preferably the compound II is bixafen, boscalid, fluopyram, fluxapyroxad, isopyrazam, penflufen, penthiopyrad or sedaxane.

With regard to the use in a pesticidal mixture of the present invention, the compound II selected from group F.Id).

More preferably the compound II is ametoctradin or silthiofam.

With regard to the use in a pesticidal mixture of the present invention, the compound II selected from group F.IIa).

More preferably the compound II is difenoconazole, epoxiconazole, fluquinconazole, flusilazole, flutriafol, ipconazole, metconazole, prothioconazole, tebuconazole, triticonazole or prochloraz.

With regard to the use in a pesticidal mixture of the present invention, the compound II selected from group F.IIb).

With regard to the use in a pesticidal mixture of the present invention, the compound II selected from group F.IIIa).

More preferably the compound II is metalaxyl and mefenoxam (metalaxyl-M).

With regard to the use in a pesticidal mixture of the present invention, the compound II selected from group F.IIIb).

With regard to the use in a pesticidal mixture of the present invention, the compound II selected from group F.IVa).

More preferably the compound II is benomyl, carbendazim, and thiophanate-methyl.

With regard to the use in a pesticidal mixture of the present invention, the compound II selected from group F.IVb).

More preferably the compound II is ethaboxam, fluopicolide or pyriofenone.

With regard to the use in a pesticidal mixture of the present invention, the compound II selected from group F.Va).

With regard to the use in a pesticidal mixture of the present invention, the compound II selected from group F.Vb).

With regard to the use in a pesticidal mixture of the present invention, the compound II selected from group F.VIa).

With regard to the use in a pesticidal mixture of the present invention, the compound II selected from group F.VIb).

With regard to the use in a pesticidal mixture of the present invention, the compound II selected from group F.VIIa).

With regard to the use in a pesticidal mixture of the present invention, the compound II selected from group F.VIIb).

With regard to the use in a pesticidal mixture of the present invention, the compound II selected from group F.VIIc).

More preferably the compound II is dimethomorph.

With regard to the use in a pesticidal mixture of the present invention, the compound II selected from group F.VIId).

With regard to the use in a pesticidal mixture of the present invention, the compound II selected from group F.VIIIa).

More preferably the compound II is sulfur.

More preferably the compound II is a copper salt selected from copper acetate, copper hydroxide, copper oxychloride or basic copper sulfate.

With regard to the use in a pesticidal mixture of the present invention, the compound II selected from group F.VIIIb).

More preferably the compound II is mancozeb, metiram or propineb.

With regard to the use in a pesticidal mixture of the present invention, the compound II selected from group F.VIIIc).

More preferably the compound II is chlorothalonil.

With regard to the use in a pesticidal mixture of the present invention, the compound II selected from group F.VIIId).

With regard to the use in a pesticidal mixture of the present invention, the compound II selected from group F.IX)

With regard to the use in a pesticidal mixture of the present invention, the compound II selected from group F.X).

More preferably the compound II is phosphorous acid or its salts.

With regard to the use in a pesticidal mixture of the present invention, the compound II selected from group F.XI).

Especially preferred are pesticidal mixtures containing azoxystrobin as compound II.

Especially preferred are pesticidal mixtures containing fluoxastrobin as compound II.

Especially preferred are pesticidal mixtures containing picoxystrobin as compound II.

Especially preferred are pesticidal mixtures containing pyraclostrobin as compound II.

Especially preferred are pesticidal mixtures containing trifloxystrobin as compound II.

Especially preferred are pesticidal mixtures containing cyazofamid as compound II.

Especially preferred are pesticidal mixtures containing bixafen as compound II.

Especially preferred are pesticidal mixtures containing boscalid as compound II.

Especially preferred are pesticidal mixtures containing fluopyram as compound II.

Especially preferred are pesticidal mixtures containing fluxapyroxad as compound II.

Especially preferred are pesticidal mixtures containing isopyrazam as compound II.

Especially preferred are pesticidal mixtures containing penflufen as compound II.

Especially preferred are pesticidal mixtures containing penthiopyrad as compound II.

Especially preferred are pesticidal mixtures containing sedaxane as compound II.

Especially preferred are pesticidal mixtures containing ametoctradin as compound II.

Especially preferred are pesticidal mixtures containing the compound silthiofam as compound II.

Especially preferred are pesticidal mixtures containing epoxiconazole as compound II.

Especially preferred are pesticidal mixtures containing difenoconazole as compound II.

Especially preferred are pesticidal mixtures containing fluquinconazole as compound II.

Especially preferred are pesticidal mixtures containing flutriafol as compound II.

Especially preferred are pesticidal mixtures containing flusilazole as compound II.

Especially preferred are pesticidal mixtures containing ipconazole as compound II.

Especially preferred are pesticidal mixtures containing metconazole as compound II.

Especially preferred are pesticidal mixtures containing prothioconazole as compound II.

Especially preferred are pesticidal mixtures containing tebuconazole as compound II.

Especially preferred are pesticidal mixtures containing triticonazole as compound II.

Especially preferred are pesticidal mixtures containing the compound prochloraz as compound II.

Especially preferred are pesticidal mixtures containing the compound metalaxyl as compound II.

Especially preferred are pesticidal mixtures containing the compound mefenoxam (metalaxyl-M) as compound II.

Especially preferred are pesticidal mixtures containing benomyl as compound II.

Especially preferred are pesticidal mixtures containing the compound carbendazim as compound II.

Especially preferred are pesticidal mixtures containing the compound thiophanate-methyl as compound II.

Especially preferred are pesticidal mixtures containing ethaboxam as compound II.

Especially preferred are pesticidal mixtures containing fluopicolide as compound II.

Especially preferred are pesticidal mixtures containing pyriofenone as compound II.

Especially preferred are pesticidal mixtures containing dimethomorph as compound II.

Especially preferred are pesticidal mixtures containing the compound copper salt as compound II.

Especially preferred are pesticidal mixtures containing sulfur as compound II.

Especially preferred are pesticidal mixtures containing the compound mancozeb as compound II.

Especially preferred are pesticidal mixtures containing the compound metiram as compound II.

Especially preferred are pesticidal mixtures containing the compound propineb as compound II.

Especially preferred are pesticidal mixtures containing the compound chlorothalonil as compound II.

Especially preferred are pesticidal mixtures containing the compound phosphorous acid as compound II.

### Preferred Mixtures According to the Invention

Especially preferred are inventive mixtures wherein the compound II of group M is azoxystrobin and the compound I of formula I is a compound of Table C.I.1.

Especially preferred are inventive mixtures wherein the compound II of group M is picoxystrobin and the compound I of formula I is a compound of Table C.I.1.

Especially preferred are inventive mixtures wherein the compound II of group M is pyraclostrobin and the compound I of formula I is a compound of Table C.I.1.

Especially preferred are inventive mixtures wherein the compound II of group M is trifloxystrobin and the compound I of formula I is a compound of Table C.I.1.

Especially preferred are inventive mixtures wherein the compound II of group M is bixafen and the compound I of formula I is a compound of Table C.I.1.

Especially preferred are inventive mixtures wherein the compound II of group M is boscalid and the compound I of formula I is a compound of Table C.I.1.

Especially preferred are inventive mixtures wherein the compound II of group M is fluopyram and the compound I of formula I is a compound of Table C.I.1.

Especially preferred are inventive mixtures wherein the compound II of group M is fluxapyroxad and the compound I of formula I is a compound of Table C.I.1.

Especially preferred are inventive mixtures wherein the compound II of group M is isopyrazam and the compound I of formula I is a compound of Table C.I.1.

Especially preferred are inventive mixtures wherein the compound II of group M is penflufen and the compound I of formula I is a compound of Table C.I.1.

Especially preferred are inventive mixtures wherein the compound II of group M is penthiopyrad and the compound I of formula I is a compound of Table C.I.1.

Especially preferred are inventive mixtures wherein the compound II of group M is sedaxane and the compound I of formula I is a compound of Table C.I.1.

Especially preferred are inventive mixtures wherein the compound II ametoctradin and the compound I of formula I is a compound of Table C.I.1.

Especially preferred are inventive mixtures wherein the compound II silthiofam and the compound I of formula I is a compound of Table C.I.1.

Especially preferred are inventive mixtures wherein the compound II of group M is the difenoconazol and the compound I of formula I is a compound of Table C.I.1.

Especially preferred are inventive mixtures wherein the compound II of group M is epoxiconazole and the compound I of formula I is a compound of Table C.I.1.

Especially preferred are inventive mixtures wherein the compound II of group M is fluquinconazole and the compound I of formula I is a compound of Table C.I.1.

Especially preferred are inventive mixtures wherein the compound II of group M is flusilazole and the compound I of formula I is a compound of Table C.I.1.

Especially preferred are inventive mixtures wherein the compound II of group M is flutriafol and the compound I of formula I is a compound of Table C.I.1.

Especially preferred are inventive mixtures wherein the compound II of group M is ipconazole and the compound I of formula I is a compound of Table C.I.1.

Especially preferred are inventive mixtures wherein the compound II of group M is metconazole and the compound I of formula I is a compound of Table C.I.1.

Especially preferred are inventive mixtures wherein the compound II of group M is prothioconazole and the compound I of formula I is a compound of Table C.I.1.

Especially preferred are inventive mixtures wherein the compound II of group M is tebuconazole and the compound I of formula I is a compound of Table C.I.1.

Especially preferred are inventive mixtures wherein the compound II of group M is triticonazole and the compound I of formula I is a compound of Table C.I.1.

Especially preferred are inventive mixtures wherein the compound II of group M is prochloraz and the compound I of formula I is a compound of Table C.I.1.

Especially preferred are inventive mixtures wherein the compound II of group M is metalaxyl and the compound I of formula I is a compound of Table C.I.1.

Especially preferred are inventive mixtures wherein the compound II of group M is mefenoxam (metalalxyl-M) and the compound I of formula I is a compound of Table C.I.1.

Especially preferred are inventive mixtures wherein the compound II of group M is benomyl and the compound I of formula I is a compound of Table C.I.1.

Especially preferred are inventive mixtures wherein the compound II of group M is carbendazim and the compound I of formula I is a compound of Table C.I.1.

Especially preferred are inventive mixtures wherein the compound II of group M is thiophanate-methyl and the compound I of formula I is a compound of Table C.I.1.

Especially preferred are inventive mixtures wherein the compound II of group M is ethaboxam and the compound I of formula I is a compound of Table C.I.1.

Especially preferred are inventive mixtures wherein the compound II of group M is fluopicolide and the compound I of formula I is a compound of Table C.I.1.

Especially preferred are inventive mixtures wherein the compound II of group M is pyriofenone and the compound I of formula I is a compound of Table C.I.1.

Especially preferred are inventive mixtures wherein the compound II of group M is dimethomorph and the compound I of formula I is a compound of Table C.I.1.

Especially preferred are inventive mixtures wherein the compound II of group M is a copper salt and the compound I of formula I is a compound of Table C.I.1.

Especially preferred are inventive mixtures wherein the compound II of group M is sulfur and the compound I of formula I is a compound of Table C.I.1.

Especially preferred are inventive mixtures wherein the compound II of group M is mancoceb and the compound I of formula I is a compound of Table C.I.1.

Especially preferred are inventive mixtures wherein the compound II of group M is metiram and the compound I of formula I is a compound of Table C.I.1.

Especially preferred are inventive mixtures wherein the compound II of group M is chlorothalonil and the compound I of formula I is a compound of Table C.I.1.

Especially preferred are inventive mixtures wherein the compound II of group M is phosphorous acid and the compound I of formula I is a compound of Table C.I.1.

The following table M represents preferred combinations of the active compounds I of formula I as defined in table C.I.1 and the active compounds II of group F in mixtures according to the invention:

TABLE M

| | Com- | | | Com- | |
|---|---|---|---|---|---|
| Mixture | pound-I | Compound-II | Mixture | pound-I | Compound-II |
| M.1 | C.I-1 | azoxystrobin | M.201 | C.I-1 | metalaxyl |
| M.2 | C.I.-3 | azoxystrobin | M.202 | C.I.-3 | metalaxyl |
| M.3 | C.I-4 | azoxystrobin | M.203 | C.I-4 | metalaxyl |
| M.4 | C.I-9 | azoxystrobin | M.204 | C.I-9 | metalaxyl |
| M.5 | C.I-10 | azoxystrobin | M.205 | C.I-10 | metalaxyl |
| M.6 | C.I-11 | azoxystrobin | M.206 | C.I-11 | metalaxyl |
| M.7 | C.I-13 | azoxystrobin | M.207 | C.I-13 | metalaxyl |
| M.8 | C.I-14 | azoxystrobin | M.208 | C.I-14 | metalaxyl |
| M.9 | C.I-19 | azoxystrobin | M.209 | C.I-19 | metalaxyl |
| M.10 | C.I-20 | azoxystrobin | M.210 | C.I-20 | metalaxyl |
| M.11 | C.I-1 | picoxystrobin | M.211 | C.I-1 | mefenoxam |
| M.12 | C.I.-3 | picoxystrobin | M.212 | C.I.-3 | mefenoxam |
| M.13 | C.I-4 | picoxystrobin | M.213 | C.I-4 | mefenoxam |
| M.14 | C.I-9 | picoxystrobin | M.214 | C.I-9 | mefenoxam |
| M.15 | C.I-10 | picoxystrobin | M.215 | C.I-10 | mefenoxam |
| M.16 | C.I-11 | picoxystrobin | M.216 | C.I-11 | mefenoxam |
| M.17 | C.I-13 | picoxystrobin | M.217 | C.I-13 | mefenoxam |
| M.18 | C.I-14 | picoxystrobin | M.218 | C.I-14 | mefenoxam |
| M.19 | C.I-19 | picoxystrobin | M.219 | C.I-19 | mefenoxam |
| M.20 | C.I-20 | picoxystrobin | M.220 | C.I-20 | mefenoxam |
| M.21 | C.I-1 | pyraclostrobin | M.221 | C.I-1 | carbendazim |
| M.22 | C.I.-3 | pyraclostrobin | M.222 | C.I.-3 | carbendazim |
| M.23 | C.I-4 | pyraclostrobin | M.223 | C.I-4 | carbendazim |
| M.24 | C.I-9 | pyraclostrobin | M.224 | C.I-9 | carbendazim |
| M.25 | C.I-10 | pyraclostrobin | M.225 | C.I-10 | carbendazim |
| M.26 | C.I-11 | pyraclostrobin | M.226 | C.I-11 | carbendazim |
| M.27 | C.I-13 | pyraclostrobin | M.227 | C.I-13 | carbendazim |
| M.28 | C.I-14 | pyraclostrobin | M.228 | C.I-14 | carbendazim |
| M.29 | C.I-19 | pyraclostrobin | M.229 | C.I-19 | carbendazim |
| M.30 | C.I-20 | pyraclostrobin | M.230 | C.I-20 | carbendazim |
| M.31 | C.I-1 | trifloxystrobin | M.231 | C.I-1 | benomyl |
| M.32 | C.I.-3 | trifloxystrobin | M.232 | C.I.-3 | benomyl |
| M.33 | C.I-4 | trifloxystrobin | M.233 | C.I-4 | benomyl |
| M.34 | C.I-9 | trifloxystrobin | M.234 | C.I-9 | benomyl |
| M.35 | C.I-10 | trifloxystrobin | M.235 | C.I-10 | benomyl |
| M.36 | C.I-11 | trifloxystrobin | M.236 | C.I-11 | benomyl |
| M.37 | C.I-13 | trifloxystrobin | M.237 | C.I-13 | benomyl |
| M.38 | C.I-14 | trifloxystrobin | M.238 | C.I-14 | benomyl |
| M.39 | C.I-19 | trifloxystrobin | M.239 | C.I-19 | benomyl |
| M.40 | C.I-20 | trifloxystrobin | M.240 | C.I-20 | benomyl |
| M.41 | C.I-1 | fluoxastrobin | M.241 | C.I-1 | cyazofamid |
| M.42 | C.I.-3 | fluoxastrobin | M.242 | C.I.-3 | cyazofamid |
| M.43 | C.I-4 | fluoxastrobin | M.243 | C.I-4 | cyazofamid |
| M.44 | C.I-9 | fluoxastrobin | M.244 | C.I-9 | cyazofamid |
| M.45 | C.I-10 | fluoxastrobin | M.245 | C.I-10 | cyazofamid |
| M.46 | C.I-11 | fluoxastrobin | M.246 | C.I-11 | cyazofamid |
| M.47 | C.I-13 | fluoxastrobin | M.247 | C.I-13 | cyazofamid |
| M.48 | C.I-14 | fluoxastrobin | M.248 | C.I-14 | cyazofamid |
| M.49 | C.I-19 | fluoxastrobin | M.249 | C.I-19 | cyazofamid |
| M.50 | C.I-20 | fluoxastrobin | M.250 | C.I-20 | cyazofamid |
| M.51 | C.I-1 | boscalid | M.251 | C.I-1 | flutriafol |
| M.52 | C.I.-3 | boscalid | M.252 | C.I.-3 | flutriafol |
| M.53 | C.I-4 | boscalid | M.253 | C.I-4 | flutriafol |
| M.54 | C.I-9 | boscalid | M.254 | C.I-9 | flutriafol |
| M.55 | C.I-10 | boscalid | M.255 | C.I-10 | flutriafol |
| M.56 | C.I-11 | boscalid | M.256 | C.I-11 | flutriafol |
| M.57 | C.I-13 | boscalid | M.257 | C.I-13 | flutriafol |
| M.58 | C.I-14 | boscalid | M.258 | C.I-14 | flutriafol |
| M.59 | C.I-19 | boscalid | M.259 | C.I-19 | flutriafol |
| M.60 | C.I-20 | boscalid | M.260 | C.I-20 | flutriafol |
| M.61 | C.I-1 | fluopyram | M.261 | C.I-1 | difenoconazol |
| M.62 | C.I.-3 | fluopyram | M.262 | C.I.-3 | difenoconazol |
| M.63 | C.I-4 | fluopyram | M.263 | C.I-4 | difenoconazol |
| M.64 | C.I-9 | fluopyram | M.264 | C.I-9 | difenoconazol |
| M.65 | C.I-10 | fluopyram | M.265 | C.I-10 | difenoconazol |
| M.66 | C.I-11 | fluopyram | M.266 | C.I-11 | difenoconazol |
| M.67 | C.I-13 | fluopyram | M.267 | C.I-13 | difenoconazol |
| M.68 | C.I-14 | fluopyram | M.268 | C.I-14 | difenoconazol |
| M.69 | C.I-19 | fluopyram | M.269 | C.I-19 | difenoconazol |
| M.70 | C.I-20 | fluopyram | M.270 | C.I-20 | difenoconazol |
| M.71 | C.I-1 | fluxapyroxad | M.271 | C.I-1 | bixafen |
| M.72 | C.I.-3 | fluxapyroxad | M.272 | C.I.-3 | bixafen |
| M.73 | C.I-4 | fluxapyroxad | M.273 | C.I-4 | bixafen |
| M.74 | C.I-9 | fluxapyroxad | M.274 | C.I-9 | bixafen |
| M.75 | C.I-10 | fluxapyroxad | M.275 | C.I-10 | bixafen |
| M.76 | C.I-11 | fluxapyroxad | M.276 | C.I-11 | bixafen |
| M.77 | C.I-13 | fluxapyroxad | M.277 | C.I-13 | bixafen |
| M.78 | C.I-14 | fluxapyroxad | M.278 | C.I-14 | bixafen |
| M.79 | C.I-19 | fluxapyroxad | M.279 | C.I-19 | bixafen |
| M.80 | C.I-20 | fluxapyroxad | M.280 | C.I-20 | bixafen |
| M.81 | C.I-1 | penthiopyrad | M.281 | C.I-1 | isopyrazam |
| M.82 | C.I.-3 | penthiopyrad | M.282 | C.I.-3 | isopyrazam |
| M.83 | C.I-4 | penthiopyrad | M.283 | C.I-4 | isopyrazam |
| M.84 | C.I-9 | penthiopyrad | M.284 | C.I-9 | isopyrazam |
| M.85 | C.I-10 | penthiopyrad | M.285 | C.I-10 | isopyrazam |
| M.86 | C.I-11 | penthiopyrad | M.286 | C.I-11 | isopyrazam |
| M.87 | C.I-13 | penthiopyrad | M.287 | C.I-13 | isopyrazam |
| M.88 | C.I-14 | penthiopyrad | M.288 | C.I-14 | isopyrazam |
| M.89 | C.I-19 | penthiopyrad | M.289 | C.I-19 | isopyrazam |
| M.90 | C.I-20 | penthiopyrad | M.290 | C.I-20 | isopyrazam |
| M.91 | C.I-1 | sedaxane | M.291 | C.I-1 | penflufen |
| M.92 | C.I.-3 | sedaxane | M.292 | C.I.-3 | penflufen |
| M.93 | C.I-4 | sedaxane | M.293 | C.I-4 | penflufen |
| M.94 | C.I-9 | sedaxane | M.294 | C.I-9 | penflufen |
| M.95 | C.I-10 | sedaxane | M.295 | C.I-10 | penflufen |
| M.96 | C.I-11 | sedaxane | M.296 | C.I-11 | penflufen |
| M.97 | C.I-13 | sedaxane | M.297 | C.I-13 | penflufen |
| M.98 | C.I-14 | sedaxane | M.298 | C.I-14 | penflufen |
| M.99 | C.I-19 | sedaxane | M.299 | C.I-19 | penflufen |
| M.100 | C.I-20 | sedaxane | M.300 | C.I-20 | penflufen |
| M.101 | C.I-1 | silthiofam | M.301 | C.I-1 | dimethomorph |
| M.102 | C.I.-3 | silthiofam | M.302 | C.I.-3 | dimethomorph |
| M.103 | C.I-4 | silthiofam | M.303 | C.I-4 | dimethomorph |
| M.104 | C.I-9 | silthiofam | M.304 | C.I-9 | dimethomorph |
| M.105 | C.I-10 | silthiofam | M.305 | C.I-10 | dimethomorph |
| M.106 | C.I-11 | silthiofam | M.306 | C.I-11 | dimethomorph |
| M.107 | C.I-13 | silthiofam | M.307 | C.I-13 | dimethomorph |
| M.108 | C.I-14 | silthiofam | M.308 | C.I-14 | dimethomorph |
| M.109 | C.I-19 | silthiofam | M.309 | C.I-19 | dimethomorph |
| M.110 | C.I-20 | silthiofam | M.310 | C.I-20 | dimethomorph |
| M.111 | C.I-1 | carbendazim | M.311 | C.I-1 | propineb |
| M.112 | C.I.-3 | carbendazim | M.312 | C.I.-3 | propineb |
| M.113 | C.I-4 | carbendazim | M.313 | C.I-4 | propineb |
| M.114 | C.I-9 | carbendazim | M.314 | C.I-9 | propineb |
| M.115 | C.I-10 | carbendazim | M.315 | C.I-10 | propineb |
| M.116 | C.I-11 | carbendazim | M.316 | C.I-11 | propineb |
| M.117 | C.I-13 | carbendazim | M.317 | C.I-13 | propineb |
| M.118 | C.I-14 | carbendazim | M.318 | C.I-14 | propineb |
| M.119 | C.I-19 | carbendazim | M.319 | C.I-19 | propineb |
| M.120 | C.I-20 | carbendazim | M.320 | C.I-20 | propineb |
| M.121 | C.I-1 | epoxiconazol | M.321 | C.I-1 | ametoctradin |
| M.122 | C.I.-3 | epoxiconazol | M.322 | C.I.-3 | ametoctradin |
| M.123 | C.I-4 | epoxiconazol | M.323 | C.I-4 | ametoctradin |
| M.124 | C.I-9 | epoxiconazol | M.324 | C.I-9 | ametoctradin |
| M.125 | C.I-10 | epoxiconazol | M.325 | C.I-10 | ametoctradin |
| M.126 | C.I-11 | epoxiconazol | M.326 | C.I-11 | ametoctradin |
| M.127 | C.I-13 | epoxiconazol | M.327 | C.I-13 | ametoctradin |
| M.128 | C.I-14 | epoxiconazol | M.328 | C.I-14 | ametoctradin |
| M.129 | C.I-19 | epoxiconazol | M.329 | C.I-19 | ametoctradin |
| M.130 | C.I-20 | epoxiconazol | M.330 | C.I-20 | ametoctradin |
| M.131 | C.I-1 | fluquinconazole | M.331 | C.I-1 | mancozeb |
| M.132 | C.I.-3 | fluquinconazole | M.332 | C.I.-3 | mancozeb |
| M.133 | C.I-4 | fluquinconazole | M.333 | C.I-4 | mancozeb |
| M.134 | C.I-9 | fluquinconazole | M.334 | C.I-9 | mancozeb |
| M.135 | C.I-10 | fluquinconazole | M.335 | C.I-10 | mancozeb |
| M.136 | C.I-11 | fluquinconazole | M.336 | C.I-11 | mancozeb |
| M.137 | C.I-13 | fluquinconazole | M.337 | C.I-13 | mancozeb |
| M.138 | C.I-14 | fluquinconazole | M.338 | C.I-14 | mancozeb |
| M.139 | C.I-19 | fluquinconazole | M.339 | C.I-19 | mancozeb |
| M.140 | C.I-20 | fluquinconazole | M.340 | C.I-20 | mancozeb |
| M.141 | C.I-1 | ipconazole | M.341 | C.I-1 | metiram |
| M.142 | C.I.-3 | ipconazole | M.342 | C.I.-3 | metiram |
| M.143 | C.I-4 | ipconazole | M.343 | C.I-4 | metiram |
| M.144 | C.I-9 | ipconazole | M.344 | C.I-9 | metiram |
| M.145 | C.I-10 | ipconazole | M.345 | C.I-10 | metiram |
| M.146 | C.I-11 | ipconazole | M.346 | C.I-11 | metiram |
| M.147 | C.I-13 | ipconazole | M.347 | C.I-13 | metiram |
| M.148 | C.I-14 | ipconazole | M.348 | C.I-14 | metiram |
| M.149 | C.I-19 | ipconazole | M.349 | C.I-19 | metiram |
| M.150 | C.I-20 | ipconazole | M.350 | C.I-20 | metiram |
| M.151 | C.I-1 | metconazol | M.351 | C.I-1 | copper salt |
| M.152 | C.I.-3 | metconazol | M.352 | C.I.-3 | copper salt |
| M.153 | C.I-4 | metconazol | M.353 | C.I-4 | copper salt |
| M.154 | C.I-9 | metconazol | M.354 | C.I-9 | copper salt |
| M.155 | C.I-10 | metconazol | M.355 | C.I-10 | copper salt |
| M.156 | C.I-11 | metconazol | M.356 | C.I-11 | copper salt |
| M.157 | C.I-13 | metconazol | M.357 | C.I-13 | copper salt |
| M.158 | C.I-14 | metconazol | M.358 | C.I-14 | copper salt |
| M.159 | C.I-19 | metconazol | M.359 | C.I-19 | copper salt |
| M.160 | C.I-20 | metconazol | M.360 | C.I-20 | copper salt |
| M.161 | C.I-1 | prothioconazole | M.361 | C.I-1 | sulfur |
| M.162 | C.I.-3 | prothioconazole | M.362 | C.I.-3 | sulfur |
| M.163 | C.I-4 | prothioconazole | M.363 | C.I-4 | sulfur |
| M.164 | C.I-9 | prothioconazole | M.364 | C.I-9 | sulfur |
| M.165 | C.I-10 | prothioconazole | M.365 | C.I-10 | sulfur |
| M.166 | C.I-11 | prothioconazole | M.366 | C.I-11 | sulfur |
| M.167 | C.I-13 | prothioconazole | M.367 | C.I-13 | sulfur |
| M.168 | C.I-14 | prothioconazole | M.368 | C.I-14 | sulfur |
| M.169 | C.I-19 | prothioconazole | M.369 | C.I-19 | sulfur |
| M.170 | C.I-20 | prothioconazole | M.370 | C.I-20 | sulfur |
| M.171 | C.I-1 | tebuconazole | M.371 | C.I-1 | phosphorous |
| | | | | | acid |
| M.172 | C.I.-3 | tebuconazole | M.372 | C.I.-3 | phosphorous |
| | | | | | acid |
| M.173 | C.I-4 | tebuconazole | M.373 | C.I-4 | phosphorous |
| | | | | | acid |
| M.174 | C.I-9 | tebuconazole | M.374 | C.I-9 | phosphorous |
| | | | | | acid |
| M.175 | C.I-10 | tebuconazole | M.375 | C.I-10 | phosphorous |
| | | | | | acid |
| M.176 | C.I-11 | tebuconazole | M.376 | C.I-11 | phosphorous |
| | | | | | acid |
| M.177 | C.I-13 | tebuconazole | M.377 | C.I-13 | phosphorous |
| | | | | | acid |
| M.178 | C.I-14 | tebuconazole | M.378 | C.I-14 | phosphorous |
| | | | | | acid |
| M.179 | C.I-19 | tebuconazole | M.379 | C.I-19 | phosphorous |
| | | | | | acid |
| M.180 | C.I-20 | tebuconazole | M.380 | C.I-20 | phosphorous |
| | | | | | acid |
| M.181 | C.I-1 | triticonazole | M.381 | C.I-1 | chlorothalonil |
| M.182 | C.I.-3 | triticonazole | M.382 | C.I.-3 | chlorothalonil |
| M.183 | C.I-4 | triticonazole | M.383 | C.I-4 | chlorothalonil |
| M.184 | C.I-9 | triticonazole | M.384 | C.I-9 | chlorothalonil |
| M.185 | C.I-10 | triticonazole | M.385 | C.I-10 | chlorothalonil |
| M.186 | C.I-11 | triticonazole | M.386 | C.I-11 | chlorothalonil |
| M.187 | C.I-13 | triticonazole | M.387 | C.I-13 | chlorothalonil |
| M.188 | C.I-14 | triticonazole | M.388 | C.I-14 | chlorothalonil |
| M.189 | C.I-19 | triticonazole | M.389 | C.I-19 | chlorothalonil |
| M.190 | C.I-20 | triticonazole | M.390 | C.I-20 | chlorothalonil |
| M.191 | C.I-1 | prochloraz | M.391 | C.I-1 | thiophanate- |
| | | | | | methyl |
| M.192 | C.I.-3 | prochloraz | M.392 | C.I.-3 | thiophanate- |
| | | | | | methyl |
| M.193 | C.I-4 | prochloraz | M.393 | C.I-4 | thiophanate- |
| | | | | | methyl |
| M.194 | C.I-9 | prochloraz | M.394 | C.I-9 | thiophanate- |
| | | | | | methyl |
| M.195 | C.I-10 | prochloraz | M.395 | C.I-10 | thiophanate- |
| | | | | | methyl |
| M.196 | C.I-11 | prochloraz | M.396 | C.I-11 | thiophanate- |
| | | | | | methyl |
| M.197 | C.I-13 | prochloraz | M.397 | C.I-13 | thiophanate- |
| | | | | | methyl |
| M.198 | C.I-14 | prochloraz | M.398 | C.I-14 | thiophanate- |
| | | | | | methyl |
| M.199 | C.I-19 | prochloraz | M.399 | C.I-19 | thiophanate- |
| | | | | | methyl |
| M.200 | C.I-20 | prochloraz | M.400 | C.I-20 | thiophanate- |
| | | | | | methyl |
| M.201 | C.I-1 | ethaboxam | M.401 | C.I-1 | fluopicolide |
| M.202 | C.I.-3 | ethaboxam | M.402 | C.I.-3 | fluopicolide |
| M.203 | C.I-4 | ethaboxam | M.403 | C.I-4 | fluopicolide |
| M.204 | C.I-9 | ethaboxam | M.404 | C.I-9 | fluopicolide |
| M.205 | C.I-10 | ethaboxam | M.405 | C.I-10 | fluopicolide |
| M.206 | C.I-11 | ethaboxam | M.406 | C.I-11 | fluopicolide |
| M.207 | C.I-13 | ethaboxam | M.407 | C.I-13 | fluopicolide |
| M.208 | C.I-14 | ethaboxam | M.408 | C.I-14 | fluopicolide |
| M.209 | C.I-19 | ethaboxam | M.409 | C.I-19 | fluopicolide |
| M.210 | C.I-20 | ethaboxam | M.410 | C.I-20 | fluopicolide |
| M.211 | C.I-1 | pyriofenone | M.411 | C.I-1 | flusilazole |
| M.212 | C.I.-3 | pyriofenone | M.412 | C.I.-3 | flusilazole |
| M.213 | C.I-4 | pyriofenone | M.413 | C.I-4 | flusilazole |
| M.214 | C.I-9 | pyriofenone | M.414 | C.I-9 | flusilazole |
| M.215 | C.I-10 | pyriofenone | M.415 | C.I-10 | flusilazole |
| M.216 | C.I-11 | pyriofenone | M.416 | C.I-11 | flusilazole |
| M.217 | C.I-13 | pyriofenone | M.417 | C.I-13 | flusilazole |
| M.218 | C.I-14 | pyriofenone | M.418 | C.I-14 | flusilazole |
| M.219 | C.I-19 | pyriofenone | M.419 | C.I-19 | flusilazole |
| M.220 | C.I-20 | pyriofenone | M.420 | C.I-20 | flusilazole |

Binary mixtures of a compound of formula I and a compound II from the groups F.I to F.XI are one preferred embodiment of the invention.

Ternary mixtures of a compound of formula I and two compounds II from the groups F.I to F.XI are another embodiment of the invention.

### Pests and Fungi

The mixtures of the active compounds I and II, or the active compounds I and II used simultaneously, that is jointly or separately, exhibit outstanding action against pests from the following orders:

Insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria,

flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca domestica, Muscle stabulans, Oestrus ovis, Opomyza forum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga sp., Simulium vittatum, Stomoxys calcitrans, Tabanus bovinus, Tabanus atratus, Tabanus lineola, and Tabanus similis, Tipula oleracea, and Tipula paludosa

trips (Thysanoptera), e.g. Dichromothrips corbetti, Dichromothrips ssp, Frankliniella fusca, Frankliniella occidentalis, Frankliniella tritici, Scirtothrips citri, Thrips oryzae, Thrips palmi and Thrips tabaci,

termites (Isoptera), e.g. Calotermes flavicollis, Leucotermes flavipes, Heterotermes aureus, Reticulitermes flavipes, Reticulitermes virginicus, Reticulitermes lucifugus, Termes natalensis, and Coptotermes formosanus,

cockroaches (Blattaria-Blattodea), e.g. Blattella germanica, Blattella asahinae, Periplanta americana, Periplaneta japonica, Periplaneta brunnea, Periplaneta fuligginosa, Periplaneta australasiae, and Blatta orientalis,

true bugs (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifolii, Cimex lectularius, Cimex hemipterus, Reduvius senilis, Triatoma spp., and Arilus critatus.

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Pheidole megacephala, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,

crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina,

Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor sllvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni, Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and Oligonychus pratensis; Araneida, e.g. Latrodectus mactans, and Loxosceles reclusa,

fleas (Siphonaptera), e.g. Ctenocephalides felis, Ctenocephalides canis, Xenopsylla cheopis, Pulex irritans, Tunga penetrans, and Nosopsyllus fasciatus,

silverfish, firebrat (Thysanura), e.g. Lepisma saccharina and Thermobia domestica,

centipedes (Chilopoda), e.g. Scutigera coleoptrata,

millipedes (Diplopoda), e.g. Narceus spp.,

Earwigs (Dermaptera), e.g. forficula auricularia,

lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus.

Plant parasitic nematodes such as root-knot nematodes, Meloidogyne arenaria, Meloidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchodes besseyi, Aphelenchoides fragariae, Aphelenchodes ritzemabosi and other Aphelenchodes species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Rotylenchus species; sheath nematodes, Hemicycliophora species and Hemicriconemoides species; Hirshmanniella species; lance nematodes, Hoplolaimus columbus, Hoplolaimus galeatus and other Hoplolaimus species, false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes, Rotylenchulus reniformis and other Rotylenchulus species; Scutellonema species; stubby root nematodes, Trichodorus primitivus and other Trichodorus species; Paratrichodorus minor and other Paratrichodorus species; stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xiphinema species; and other plant parasitic nematode species. Moreover, the inventive mixtures are preferably useful for the control of nematodes of the order of Rhabditida, especially Rhabditidae such as Caenorhabditis ssp.

The mixtures of the present invention have excellent activity against a broad spectrum of phytopathogenic fungi Ascomycetes, Basidiomycetes, Deuteromycetes and Peronosporomycetes (syn. Oomycetes). Some of them are systemically effective and can be employed in crop protection as foliar fungicides, as fungicides for seed dressing and as soil fungicides. They can also be used for treating seed.

They are particularly important in the control of a multitude of fungi on various cultivated plants, such as wheat, rye, barley, oats, rice, corn, lawns, bananas, cotton, soybean, coffee, sugar cane, grapevines, fruits and ornamental plants, and vegetables such as cucumbers, beans, tomatoes, potatoes and cucurbits, and on the seeds of these plants.

They are especially suitable for controlling the following plant diseases:
Alternaria species on vegetables, oilseed rape, sugar beet and fruit and rice, for example, A. solani or A. alternata on potatoes and tomatoes;
Aphanomyces species on sugar beet and vegetables;
Ascochyta species on cereals and vegetables;
Bipolaris and Drechslera species on corn, cereals, rice and lawns, for example, D. maydis on corn;
Blumeria graminis (powdery mildew) on cereals;
Botrytis cinerea (gray mold) on strawberries, vegetables, flowers and grapevines;
Bremia lactucae on lettuce;
Cercospora species on corn, soybeans, rice and sugar beet;
Cochliobolus species on corn, cereals, rice, for example Cochliobolus sativus on cereals, Cochliobolus miyabeanus on rice;
Colletotricum species on soybeans and cotton;
Drechslera species, Pyrenophora species on corn, cereals, rice and lawns, for example, D. teres on barley or D. tritici-repentis on wheat;
Esca on grapevines, caused by Phaeoacremonium chlamydosporium, Ph. Aleophilum and Formitipora punctata (syn. Phellinus punctatus);
Exserohilum species on corn;
Erysiphe cichoracearum and Sphaerotheca fuliginea on cucumbers;
Fusarium and Verticillium species on various plants, for example, F. graminearum or F. culmorum on cereals or F. oxysporum on a multitude of plants, such as, for example, tomatoes;
Gaeumanomyces graminis on cereals;
Gibberella species on cereals and rice (for example Gibberella fujikuroi on rice);
Grainstaining complex on rice;
Helminthosporium species on corn and rice;
Michrodochium nivale on cereals;
Mycosphaerella species on cereals, bananas and peanuts, for example, M. graminicola on wheat or M. fijiensis on bananas;
Peronospora species on cabbage and bulbous plants, for example, P. brassicae on cabbage or P. destructor on onions;
Phakopsara pachyrhizi and Phakopsara meibomiae on soybeans;
Phomopsis species on soybeans and sunflowers;
Phytophthora infestans on potatoes and tomatoes;
Phytophthora species on various plants, for example, P. capsici on bell pepper;
Plasmopara viticola on grapevines;
Podosphaera leucotricha on apples;
Pseudocercosporella herpotrichoides on cereals;
Pseudoperonospora on various plants, for example, P. cubensis on cucumber or P. humili on hops;
Puccinia species on various plants, for example, P. triticina, P. striformins, P. hordei or P. graminis on cereals or P. asparagi on asparagus;
Pyricularia oryzae, Corticium sasakii, Sarocladium oryzae, S. attenuatum, Entyloma oryzae on rice;
Pyricularia grisea on lawns and cereals;
Pythium spp. on lawns, rice, corn, cotton, oilseed rape, sunflowers, sugar beet, vegetables and other plants, for example, P. ultiumum on various plants, P. aphanidermatum on lawns;
Rhizoctonia species on cotton, rice, potatoes, lawns, corn, oilseed rape, sugar beet, vegetables and on various plants, for example, R. solani on beet and various plants;
Rhynchosporium secalis on barley, rye and triticale;
Sclerotinia species on oilseed rape and sunflowers;
Septoria tritici and Stagonospora nodorum on wheat;
Erysiphe (syn. Uncinula) necatoron grapevines;
Setospaeria species on corn and lawns;
Sphacelotheca reilinia on corn;
Thievaliopsis species on soybeans and cotton;
Tilletia species on cereals;
Ustilago species on cereals, corn and sugar cane, for example, U. maydis on corn;
Venturia species (scab) on apples and pears, for example, V. inaequalis on apples.

The mixtures according to the invention are also suitable for controlling harmful fungi in the protection of materials (for example wood, paper, paint dispersions, fibers or fabrics) and in the protection of stored products. In the protection of wood, particular attention is paid to the following harmful fungi: Ascomycetes, such as Ophiostoma spp., Ceratocystis spp., Aureobasidium pullulans, Sclerophoma spp., Chaetomium spp., Humicola spp., Petriella spp., Trichurus spp.; Basidiomycetes, such as Coniophora spp., Coriolus spp., Gloeophyllum spp., Lentinus spp., Pleurotus spp., Poria spp., Serpula spp. and Tyromyces spp., Deuteromycetes, such as Aspergillus spp., Cladosporium spp., Penicillium spp., Trichoderma spp., Alternaria spp., Paecilomyces spp. and Zygomycetes, such as Mucor spp., additionally in the protection of materials the following yeasts: Candida spp. and Saccharomyces cerevisae.

The mixtures of the present invention are especially suitable for efficiently combating pests like insects from the order of the lepidopterans (Lepidoptera), beetles (Coleoptera), flies and mosquitoes (Diptera), thrips (Thysanoptera), termites (Isoptera), bugs, aphids, leafhoppers, whiteflies, scale insects, cicadas (Hemiptera), ants, bees, wasps, sawflies (Hymenoptera), crickets, grasshoppers, locusts (Orthoptera), and also Arachnoidea, such as arachnids (Acarina).

Moreover, the inventive mixtures are preferably useful for the control of Arachnoidae, especially for arachnids (Acarina) and more especially against mites (Tetranychus spp).

### Formulations

The mixtures according to the present invention can be converted into the customary formulations, for example solutions, emulsions, suspensions, dusts, powders, pastes and granules. The use form depends on the particular intended purpose; in each case, it should ensure a fine and even distribution of the compounds according to the invention.

Therefore the invention also relates to agrochemical compositions comprising an auxiliary and a mixture of at least one compound I of formula I and of at least one compound II according to the present invention.

An agrochemical composition comprises a pesticidally effective amount of a pesticidal mixture. The term “effective amount” denotes an amount of the composition or of the mixture, which is sufficient for controlling harmful pests or fungi on cultivated plants or in the protection of materials and which does not result in a substantial damage to the treated plants. Such an amount can vary in a broad range and is dependent on various factors, such as the animal pests species to be con-trolled, the treated cultivated plant or material, the climatic conditions and the specific mixture used.

The mixture according to the present invention can be converted into customary types of agrochemical compositions, e.g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International.

The compositions are prepared in a known manner, such as described by Mollet and Grube-mann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, lime-stone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyland tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkyl-polyglucosides. Examples of polymeric surfactants are home- or copolymers of vinylpyrrolidone, vinyl-alcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or poly-ethyleneamines.

Suitable adjuvants are compounds, which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

The agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying compound I and compositions thereof, respectively, on to plant propagation material, especially seeds include dressing, coating, pelleting, dusting, soaking and in-furrow application methods of the propagation material. Preferably, compound I or the compositions thereof, respectively, are applied on to the plant propagation material by a method such that germination is not induced, e.g. by seed dressing, pelleting, coating and dusting.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

In treatment of plant propagation materials such as seeds, e.g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seeds) are generally required. When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, e.g. components comprising compounds I of formula I and compounds II from group M, may be mixed by the user in a spray tank and further auxiliaries and additives may be added, if appropriate. In a further embodiment, either individual components of the composition according to the invention or partially premixed components, e.g. components comprising compounds I formula I and compounds II from group M, can be applied jointly (e.g. after tank mix) or consecutively, meaning creating the mixture “in-situ”.

### Applications

The compounds I and the one or more compound(s) II can be applied simultaneously, that is jointly or separately, or in succession, that is immediately one after another and thereby creating the mixture “in-situ” on the desired location, as e.g. the plant, the sequence, in the case of separate application, generally not having any effect on the result of the control measures.

The mixtures of the present invention are employed as such or in form of compositions by treating the insects, the fungi or the plants, plant propagation materials, such as seeds, soil, surfaces, materials or rooms to be protected from insecticidal attack with a pesticidally effective amount of the active compounds. The application can be carried out both before and after the infection of the plants, plant propagation materials, such as seeds, soil, surfaces, materials or rooms by the insects.

The present invention also includes a method of combating animal pests and harmful fungi which comprises contacting the fungi and/or animal pests, their habit, breeding ground, food supply, cultivated plants, seed, soil, area, material or environment in which the animal pests are growing or may grow, or the materials, plants, seeds, soils, surfaces or spaces to be protected from animal attack or infestation with a pesticidally effective amount of a mixture according to the present invention.

Plants which can be treated with the inventive mixtures include all genetically modified plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

Some of the inventive mixtures have systemic action and can therefore be used for the protection of the plant shoot against foliar pests as well as for the treatment of the seed and roots against soil pests.

The mixtures of compounds I and II or their corresponding formulations are applied by treating the harmful fungi and the animal pests, their habitat or the plants, seeds, soils, areas, materials or spaces to be kept free from them with a pesticidally effective amount of the mixture or, in the case of separate application, of the compounds I and II. Application can be before or after the infection by harmful fungi and/or animal pests.

The compounds I and the one or more compound(s) II are usually applied in a weight ratio of from 500:1 to 1:100, preferably from 20:1 to 1:50, in particular from 5:1 to 1:20. Depending on the desired effect, the application rates of the mixtures according to the invention are from 5 g/ha to 2000 g/ha, preferably from 50 to 1500 g/ha, in particular from 50 to 750 g/ha.

In general, “synergistically effective amount” means that the one or more active compound(s) I and the one or more active compound(s) II are usually applied in a weight ratio of from 500:1 to 1:100, preferably from 20:1 to 1:50, in particular from 5:1 to 1:20. Depending on the nature of the compounds the employed weight ratio of compound(s) I and compound(s) II ranges can start from 100:1 to 1:100, preferably from 20:1 to 1:20, in particular from 10:1 to 1:10.

Further active compounds are, if desired, mixed in a ratio of from 20:1 to 1:20 to the compound I.

The mixtures according to the invention are effective through both contact and ingestion.

According to a preferred embodiment of the invention, the mixtures according to the present invention are employed via soil application. Soil application is especially favorable for use against ants, termites, crickets, or cockroaches.

According to another preferred embodiment of the invention, for use against non crop pests such as ants, termites, wasps, flies, mosquitoes, crickets, locusts, or cockroaches the mixtures according to the present invention are prepared into a bait preparation.

The bait can be a liquid, a solid or a semisolid preparation (e.g. a gel).

Another aspect of the present invention is when preparing the mixtures, it is preferred to employ the pure active compounds I and II, to which further active compounds, e.g. against harmful fungi or having herbicidal activity, or growth-regulating agents or fertilizers can be added.

Compositions of this invention may further contain other active ingredients than those listed above. For example fungicides, herbicides, fertilizers such as ammonium nitrate, urea, potash, and superphosphate, phytotoxicants and plant growth regulators and safeners. These additional ingredients may be used sequentially or in combination with the above-described compositions, if appropriate also added only immediately prior to use (tank mix). For example, the plant(s) may be sprayed with a composition of this invention either before or after being treated with other active ingredients.

The mixtures according to the invention can be applied to any and all developmental stages, such as egg, larva, pupa, and adult. The pests may be controlled by contacting the target pest, its food supply, habitat, breeding ground or its locus with a pesticidally effective amount of the inventive mixtures or of compositions comprising the mixtures.

“Locus” means a plant, seed, soil, area, material or environment in which a pest is growing or may grow.

In general, “pesticidally effective amount” means the amount of the inventive mixtures or of compositions comprising the mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures and/or compositions used in the invention. A pesticidally effective amount of the mixtures and/or compositions will also vary according to the prevailing conditions such as desired pesticidal effect and duration, weather, target species, locus, mode of application, and the like.

The inventive mixtures or compositions of these mixtures can also be employed for protecting plants from attack or infestation by insects, acarids or nematodes comprising contacting a plant, or soil or water in which the plant is growing.

The inventive mixtures are effective through both contact (via soil, glass, wall, bed net, carpet, plant parts or animal parts), and ingestion (bait, or plant part) and through trophallaxis and transfer.

Preferred application methods are into water bodies, via soil, cracks and crevices, pastures, manure piles, sewers, into water, on floor, wall, or by perimeter spray application and bait.

According to another preferred embodiment of the invention, for use against non crop pests such as ants, termites, wasps, flies, mosquitoes, crickets, locusts, or cockroaches the inventive mixtures are prepared into a bait preparation.

The bait can be a liquid, a solid or a semisolid preparation (e.g. a gel). The bait employed in the composition is a product which is sufficiently attractive to incite insects such as ants, termites, wasps, flies, mosquitoes, crickets etc. or cockroaches to eat it. This attractant may be chosen from feeding stimulants or para and/or sex pheromones readily known in the art.

Methods to control infectious diseases transmitted by insects (e.g. malaria, dengue and yellow fever, lymphatic filariasis, and leishmaniasis) with the inventive mixtures and their respective compositions also comprise treating surfaces of huts and houses, air spraying and impregnation of curtains, tents, clothing items, bed nets, tsetse-fly trap or the like. Insecticidal compositions for application to fibers, fabric, knitgoods, non-wovens, netting material or foils and tarpaulins preferably comprise a composition including the inventive mixtures, optionally a repellent and at least one binder.

The inventive mixtures and the compositions comprising them can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities).

In the case of soil treatment or of application to the pests dwelling place or nest, the quantity of active ingredient(s) ranges from 0.0001 to 500 g per 100 m², preferably from 0.001 to 20 g per 100 m².

Customary application rates in the protection of materials are, for example, from 0.01 g to 1000 g of active compound(s) per m² treated material, desirably from 0.1 g to 50 g per m².

Insecticidal compositions for use in the impregnation of materials typically contain from 0.001 to 95 weight %, preferably from 0.1 to 45 weight %, and more preferably from 1 to 25 weight % of at least one repellent and/or insecticide.

For use in bait compositions, the typical content of active ingredient(s) is from 0.0001 weight % to 15 weight %, desirably from 0.001 weight % to 5% weight % of active compound. The composition used may also comprise other additives such as a solvent of the active material, a flavoring agent, a preserving agent, a dye or a bitter agent. Its attractiveness may also be enhanced by a special color, shape or texture.

For use in spray compositions, the content of the mixture of the active ingredients is from 0.001 to 80 weights %, preferably from 0.01 to 50 weight % and most preferably from 0.01 to 15 weight %.

For use in treating crop plants, the rate of application of the mixture of the active ingredients of this invention may be in the range of 0.1 g to 4000 g per hectare, desirably from 25 g to 600 g per hectare, more desirably from 50 g to 500 g per hectare.

In the context of the present invention, the term plant refers to an entire plant, a part of the plant or the plant propagation material.

The mixtures of the present invention and the compositions comprising them are particularly important in the control of a multitude of insects on various cultivated plants.

Plants which can be treated with the inventive mixtures include all genetically modified plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be mentioned. These young plants may also be protected before transplantation by a total or partial treatment by immersion or pouring.

The term “cultivated plants” is to be understood as including plants which have been modified by breeding, mutagenesis or genetic engineering. Genetically modified plants are plants, which genetic material has been so modified by the use of recombinant DNA techniques that under natural circumstances cannot be obtained by cross breeding, mutations or natural recombination. Typically, one or more genes have been integrated into the genetic material of a genetically modified plant in order to improve certain properties of the plant.

The term “cultivated plants” is to be understood also including plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A-0242236, EP-A-242246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e.g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” is to be understood also including plants that are by the use of recombinant DNA techniques capable to synthesize one or more insecticidal proteins, especially those known from the bacterial genus Bacillus, particularly from Bacillus thuringiensis, such as ä-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically-modified plants capable of synthesizing such toxins are disclosed, for example, in EP-A 374 753, WO 93/007278, WO 95/34656, EP-A 427 529, EP-A 451 878, WO 03/018810 and WO 03/052073. The methods for producing such genetically modified plants are generally known to the person skilled in the art and are described, for example, in the publications mentioned above. These insecticidal proteins contained in the genetically modified plants impart to the plants producing these proteins tolerance to harmful pests from all taxonomic groups of insects, especially to beetles (Coeloptera), two-winged insects (Diptera), and butterflies (Lepidoptera).

The term “cultivated plants” is to be understood also including plants that are by the use of recombinant DNA techniques capable to synthesize one or more proteins to in-crease the resistance or tolerance of those plants to bacterial, viral or fungal pathogens. Examples of such proteins are the so-called “pathogenesis-related proteins” (PR proteins, see, for example EP-A 0 392 225), plant disease resistance genes (for example potato cultivars, which express resistance genes acting against Phytophthora infestans derived from the mexican wild potato Solanum bulbocastanum) or T4-lyso-zym (e.g. potato cultivars capable of synthesizing these proteins with increased resistance against bacteria such as Erwinia amylvora). The methods for producing such genetically modified plants are generally known to the person skilled in the art and are described, for example, in the publications mentioned above.

The term “cultivated plants” is to be understood also including plants that are by the use of recombinant DNA techniques capable to synthesize one or more proteins to increase the productivity (e.g. bio mass production, grain yield, starch content, oil content or protein content), tolerance to drought, salinity or other growth-limiting environ-mental factors or tolerance to pests and fungal, bacterial or viral pathogens of those plants.

The term “cultivated plants” is to be understood also including plants that contain by the use of recombinant DNA techniques a modified amount of substances of content or new substances of content, specifically to improve human or animal nutrition, for example oil crops that produce health-promoting long-chain omega-3 fatty acids or unsaturated omega-9 fatty acids (e.g. Nexera® rape).

The term “cultivated plants” is to be understood also including plants that contain by the use of recombinant DNA techniques a modified amount of substances of content or new substances of content, specifically to improve raw material production, for example potatoes that produce increased amounts of amylopectin (e.g. Amflora® potato).

Some of the inventive mixtures have systemic action and can therefore be used for the protection of the plant shoot against foliar pests as well as for the treatment of the seed and roots against soil pests.

### Seed Treatment

The mixtures according to the present invention are therefore suitable for the treatment of seeds in order to protect the seed from insect pest, in particular from soil-living insect pests and the resulting plant's roots and shoots against soil pests and foliar insects. The protection of the resulting plant's roots and shoots is preferred.

More preferred is the protection of resulting plant's shoots from piercing and sucking insects.

The present invention therefore comprises a method for the protection of seeds from insects, in particular from soil insects and of the seedlings' roots and shoots from insects, in particular from soil and foliar insects, said method comprising contacting the seeds before sowing and/or after pregermination with mixtures according to the present invention. Particularly preferred is a method, wherein the plant's roots and shoots are protected, more preferably a method, wherein the plants shoots are protected form piercing and sucking insects, most preferably a method, wherein the plants shoots are protected from aphids.

The term seed embraces seeds and plant propagules of all kinds including but not limited to true seeds, seed pieces, suckers, corms, bulbs, fruit, tubers, grains, cuttings, cut shoots and the like and means in a preferred embodiment true seeds.

The term seed treatment comprises all suitable seed treatment techniques known in the art, such as seed dressing, seed coating, seed dusting, seed soaking and seed pelleting.

The present invention also comprises seeds coated with or containing the active compound(s). The term “coated with and/or containing” generally signifies that the active ingredient(s) are for the most part on the surface of the propagation product at the time of application, although a greater or lesser part of the ingredient may penetrate into the propagation product, depending on the method of application. When the said propagation product are (re)planted, it may absorb the active ingredient.

Suitable seeds are seeds of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

In addition, the mixtures according to the invention may also be used for the treatment seeds from plants, which tolerate the action of herbicides or fungicides or insecticides owing to breeding, including genetic engineering methods.

For example, the active mixtures can be employed in treatment of seeds from plants, which are resistant to herbicides from the group consisting of the sulfonylureas, imidazolinones, glufosinate-ammonium or glyphosate-isopropylammonium and analogous active substances (see for example, EP-A-0242236, EP-A-242246) (WO 92/00377) (EP-A-0257993, U.S. Pat. No. 5,013,659) or in transgenic crop plants, for example cotton, with the capability of producing Bacillus thuringiensis toxins (Bt toxins) which make the plants resistant to certain pests (EP-A-0142924, EP-A-0193259),

Furthermore, the mixtures according to the present invention can be used also for the treatment of seeds from plants, which have modified characteristics in comparison with existing plants consist, which can be generated for example by traditional breeding methods and/or the generation of mutants, or by recombinant procedures). For example, a number of cases have been described of recombinant modifications of crop plants for the purpose of modifying the starch synthesized in the plants (e.g. WO 92/11376, WO 92/14827, WO 91/19806) or of transgenic crop plants having a modified fatty acid composition (WO 91/13972).

The seed treatment application of the mixtures is carried out by spraying or by dusting the seeds before sowing of the plants and before emergence of the plants.

In the treatment of seeds the corresponding formulations are applied by treating the seeds with an effective amount of the mixture according to the present invention. Herein, the application rates of the active compound(s) are generally from 0.1 g to 10 kg per 100 kg of seed, preferably from 1 g to 5 kg per 100 kg of seed, in particular from 1 g to 2.5 kg per 100 kg of seed. For specific crops such as lettuce the rate can be higher.

Compositions, which are especially useful for seed treatment are e.g.:

A Soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-Formulations (GF)

I Dustable powders (DP, DS)

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter

In a preferred embodiment a FS formulation is used for seed treatment. Typically, a FS formulation may comprise 1-800 g/l of active ingredient(s), 1-200 g/l Surfactant, 0 to 200 g/l antifreezing agent, 0 to 400 g/l of binder, 0 to 200 g/l of a pigment and up to 1 liter of a solvent, preferably water.

Preferred FS formulations of compounds of formula I for seed treatment usually comprise from 0.1 to 80% by weight (1 to 800 g/l) of the active ingredient(s), from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

Seed Treatment formulations may additionally also comprise binders and optionally colorants.

Binders can be added to improve the adhesion of the active materials on the seeds after treatment. Suitable binders are block copolymers EO/PO surfactants but also polyvinylalcohols, polyvinylpyrrolidones, polyacrylates, polymethacrylates, polybutenes, polyisobutylenes, polystyrene, polyethyleneamines, polyethyleneamides, polyethyleneimines (Lupasol®, Polymin®), polyethers, polyurethans, polyvinylacetate, tylose and copolymers derived from these polymers.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

The invention also relates to seed comprising mixtures according to the present invention. The amount of the compound I or the agriculturally useful salt thereof will in general vary from 0.1 g to 10 kg per 100 kg of seed, preferably from 1 g to 5 kg per 100 kg of seed, in particular from 1 g to 1000 g per 100 kg of seed.

### EXAMPLES

The present invention is now illustrated in further detail by the following examples.

The compounds I of formula I can be accomplished according to standard methods of organic chemistry, e.g. by the methods or working examples described in WO 2010/100189.

Some of the preferred compound I examples are characterized in following table CE.I.1 and further by their physical data in the subsequent table CE.I.1-D.1.

The characterization can be done by coupled High Performance Liquid Chromatography/mass spectrometry (HPLC/MS), by NMR or by their melting points.

The compounds I were characterized by ¹H-NMR spectroscopy. The signals are characterized by chemical shift (ppm) vs. tetramethylsilane, by their multiplicity and by their integral (relative number of hydrogen atoms given). The following abbreviations are used to characterize the multiplicity of the signals: M=multiplet, q=quartet, t=triplet, d=doublet and s=singulet.

The compounds I were also characterized by LC-MS (High Performance Liquid Chromatography Mass Spectrometry HPLC/MS). The compounds I of formula I were preferably characterized by HPLC, which was carried out using an analytic RP-18 column (Chromolith Speed ROD from Merck KGaA, Germany) which was operated at 40° C. Acetonitrile with 0.1% by volume of a trifluoroacetic acid/water mixture and 0.1% by volume of trifluoroacetic acid served as mobile phase; flow rate: 1.8 mL/min and injection volume: 2 μl.

Some specific compound examples of arylquinazolinone compounds I of formula (I)

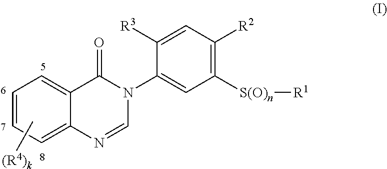

of the present invention are listed in table CE.1 hereinafter, and their respective physical date are provided in subsequent table CE-D.1:

TABLE CE.I.1*

| Compound | (R⁴)ₖ | R³ | R² | R¹ | n |
|---|---|---|---|---|---|
| CE.I.1. | k = 0 | F | CH₃ | CF₃—CH₂— | 2 |
| CE.I.2. | k = 0 | F | CH₃ | n-propyl | 0 |
| CE.I.3. | k = 0 | F | CH₃ | n-propyl | 1 |
| CE.I.4. | 8-CH₃ | F | CH₃ | CF₃—CH₂— | 0 |
| CE.I.5. | 8-CH₃ | F | CH₃ | CF₃—CH₂— | 1 |
| CE.I.6. | 8-Cl | F | CH₃ | CF₃—CH₂— | 0 |
| CE.I.7. | 8-Cl | F | CH₃ | CF₃—CH₂— | 1 |
| CE.I.8. | k = 0 | F | CH₃ | 3,4,4-trifluoro-3-buten-1-yl | 0 |
| CE.I.9. | k = 0 | F | CH₃ | 3,4,4-trifluoro-3-buten-1-yl | 1 |
| CE.I.10. | k = 0 | H | CH₃ | CF₃—CH₂— | 0 |
| CE.I.11. | k = 0 | H | CH₃ | CF₃—CH₂— | 1 |
| CE.I.12. | k = 0 | F | CH₃ | cyclopropylmethyl | 0 |
| CE.I.13. | k = 0 | F | CH₃ | cyclopropylmethyl | 1 |
| CE.I.14. | 6-Cl | F | CH₃ | CF₃—CH₂— | 0 |
| CE.I.15. | 6-Cl | F | CH₃ | CF₃—CH₂— | 1 |
| CE.I.16. | 7-CH₃ | F | CH₃ | CF₃—CH₂— | 0 |
| CE.I.17. | 7-CH₃ | F | CH₃ | CF₃—CH₂— | 1 |
| CE.I.18. | 7-Cl | F | CH₃ | CF₃—CH₂— | 0 |
| CE.I.19. | 7-Cl | F | CH₃ | CF₃—CH₂— | 1 |
| CE.I.20. | 6-OCH₃ | F | CH₃ | CF₃—CH₂— | 0 |
| CE.I.21. | 6-OCH₃ | F | CH₃ | CF₃—CH₂— | 1 |
| CE.I.22. | 5-CH₃ | F | CH₃ | CF₃—CH₂— | 0 |
| CE.I.23. | 5-CH₃ | F | CH₃ | CF₃—CH₂— | 1 |
| CE.I.24. | 6-CH₃ | F | CH₃ | CF₃—CH₂— | 0 |
| CE.I.25. | 6-CH₃ | F | CH₃ | CF₃—CH₂— | 1 |
| CE.I.26. | 5-Cl | F | CH₃ | CF₃—CH₂— | 0 |
| CE.I.27. | 5-Cl | F | CH₃ | CF₃—CH₂— | 1 |
| CE.I.28. | k = 0 | CH₃ | CH₃ | CF₃—CH₂— | 0 |
| CE.I.29. | k = 0 | CH₃ | CH₃ | CF₃—CH₂— | 1 |
| CE.I.30. | 6-F | F | CH₃ | CF₃—CH₂— | 0 |
| CE.I.31. | 6-F | F | CH₃ | CF₃—CH₂— | 1 |
| CE.I.32. | 6-CF₃O | F | CH₃ | CF₃—CH₂— | 0 |
| CE.I.33. | 6-CF₃O | F | CH₃ | CF₃—CH₂— | 1 |
| CE.I.34. | k = 0 | F | CH₃ | CF₃—CH₂— | 0 |
| CE.I.35. | k = 0 | F | CH₃ | CF₃—CH₂— | 1 |

*some compound examples of table CE.I.1 have also been described as preferred compounds I of the present invention in table C.I.1;

TABLE CE.I.1.-D.1

| Compound | Physico-chemical data: ¹H-NMR (400 MHz) δ or r.t. [min]/M⁺ |
|---|---|
| CE.I.1. | 3.13 min/400.05 |
| CE.I.2. | CDCl₃: δ = 8.39~8.36 (m, 1H), 8.01 (s, 1H), 7.84~7.77 (m, 2H), |
| | 7.58~7.54 (m, 1H), 7.28~7.25 (m, 1H), 7.17 (d, 1H, J = 10.4 Hz), |
| | 2.88~2.84 (m, 2H), 2.45 (s, 3H), 1.74~1.65 (m, 2H), |
| | 1.06~1.04 (m, 3H) |
| CE.I.3. | CDCl₃: δ = 8.37~8.35 (m, 1H), 8.01 (s, 1H), 8.01 (s, 1H), 7.98 (d, |
| | 1H, J = 7.0 Hz), 7.85~7.78 (m, 2H), 7.59~7.55 (m, 1H), 7.18 (d, |
| | 1H, J = 10 Hz), 2.86~2.72 (m, 2H), 2.46 (s, 3H), 1.94~1.73 (m, |
| | 2H), 1.25 (s, 3H) |
| CE.I.4. | CD₃OD: δ = 8.19 (s, 1H), 8.13~8.11 (m, 1H), 7.78 (d, 1H, J = 7.2 Hz), |
| | 7.33 (d, 1H, J = 10.8 Hz), 3.73~3.66 (m, 2H), 2.64 (s, 3H), |
| | 2.56 (s, 3H) |
| CE.I.5. | CDCl₃: δ = 8.13 (d, 1H, J = 8 Hz), 8.01 (d, 1H, J = 7.2 Hz), |
| | 7.94 (s, 1H), 7.62 (d, 1H, J = 7.2 Hz), 7.41~7.31 (m, 1H), |
| | 7.19~7.17 (m, 1H), 3.48~3.40 (m, 2H), 2.6 (s, 3H), 2.42 (s, 3H) |
| CE.I.6. | CD₃OD: δ = 8.29 (s, 1H), 8.24~8.21 (m, 1H), 7.99~7.97 (m, 1H), |
| | 7.80 (d, 1H, J = 7.2 Hz), 7.58~7.54 (m, 1H), 7.35~7.32 (m, 1H), |
| | 3.73~3.66 (m, 2H), 2.56 (s, 3H) |
| CE.I.7. | CD₃OD: δ = 8.36 (s, 1H), 8.25~8.23 (m, 1H), 8.12 (d, 1H, J = 7.2 Hz), |
| | 8.01~7.99 (m, 1H), 7.60~7.55 (m, 1H), 7.46~7.45 (m, |
| | 1H), 4.09~3.84 (m, 2H), 2.53 (s, 3H) |
| CE.I.8. | CDCl₃: δ = 8.31~8.29 (m, 1H), 7.93 (s, 1H), 7.78~7.70 (m, 2H), |
| | 7.52~7.48 (m, 1H), 7.30~7.28 (d, 1H, J = 7.2 Hz), 7.12~7.1 (d, |
| | 1H, J = 10 Hz), 3.01~2.98 (m, 2H), 2.61~2.50 (m, 2H), 2.41 (s, |
| | 3H) |
| CE.I.9. | CDCl₃: δ = 8.36 (t, 1H, J = 0.8 Hz), 8.02 (d, 1H, J = 0.8 Hz), |
| | 8.00 (d, 1H, J = 7.2 Hz), 7.61~7.56 (m, 1H), 7.23 (d, 1H, J = 9.6 Hz), |
| | 3.15~3.11 (m, 1H), 3.09~2.87 (m, 2H), 2.87~2.68 (m, 1H), |
| | 2.47 (s, 3H) |
| CE.I.10. | DMSO~d₆: δ = 8.32 (s, 1H), 8.21 (d, 1H, J = 8 Hz), 7.90~7.88 (m, |
| | 1H), 7.46~7.23 (m, 2H), 7.63~7.61 (m, 1H), 7.45~7.43 (m, 1H), |
| | 7.37 (dd, 1H, J = 1 Hz, 8 Hz), 4.08~4.06 (m, 2H), 2.42 (s, 3H) |
| CE.I.11. | DMSO~d₆: δ = 8.41 (s, 1H), 8.22 (d, J = 8 Hz), 7.91 (dd, 1H, J = 1.6 Hz, |
| | 7.6 Hz), 7.89 (d, 1H, J = 7.6 Hz), 7.78~7.70 (m, 2H), |
| | 7.64~7.55 (m, 2H), 7.26~7.04 (m, 2H), 2.32 (s, 3H) |
| CE.I.12. | CDCl₃: δ = 8.14 (d, 1H, J = 9.2 Hz), 7.79 (s, 1H), 7.59~7.54 (m, |
| | 2H), 7.35~7.13 (m, 1H), 7.08 (d, 1H, J = 7.2 Hz), 6.91 (d, 1H, J = 12.4 Hz), |
| | 2.58 (d, 1H, J = 6.8 Hz), 2.24 (s, 3H), 0.82~0.80 (m, |
| | 1H), 0.39~0.34 (m, 2H), 0.04~0.03 (m, 2H) |
| CE.I.13. | CDCl₃: δ = 8.36~8.34 (m, 1H), 8.02~8.00 (m, 2H), 7.83~7.78 (m, |
| | 2H), 7.58 (t, 1H, J = 5.6 Hz), 7.17 (d, 1H, J = 10.4 Hz), |
| | 2.81~2.75 (m, 2H), 2.46 (s, 3H), 1.10~1.086 (m, 1H), 0.71~0.66 (m, 2H), |
| | 0.31~0.28 (m, 2H) |
| CE.I.14. | CDCl₃: δ = 8.25 (d, 1H, J = 2.4 Hz), 7.910 (s, 1H), |
| | 7.707~7.647 (m, 2H), 7.51 (d, 1H, J = 7.2 Hz), 7.16 (t, 1H, J = 11.2 Hz), |
| | 3.341~3.269 (m, 2H), 2.500 (s, 3H) |
| CE.I.15. | CDCl₃: δ = 8.24 (d, 1H, J = 2.8 Hz), 8.010~7.923 (m, 1H), |
| | 7.921 (s, 1H), 7.724~7.663 (m, 2H), 7.206~7.181 (m, 1H), |
| | 3.478~3.404 (m, 2H), 2.425 (s, 3H) |
| CE.I.16. | CD₃OD: δ = 8.25 (d, 1H, J = 8 Hz), 7.97 (d, 1H, J = 0.8 Hz), |
| | 7.61~7.58 (m, 2H), 7.41~7.39 (m, 1H), 7.23~7.21 (m, 1H) |
| | 3.43~3.36 (m, 2H), 2.58 (s, 3H), 2.56 (s, 3H) |
| CE.I.17. | CDCl₃: δ = 8.24 (d, 1H, J = 8 Hz), 8.09 (d, 1H, J = 7.2 Hz), |
| | 7.99 (s, 1H), 7.59 (s, 1H), 7.42~7.39 (m, 1H), 7.26 (d, 1H, J = 10.4 Hz), |
| | 3.57~3.48 (m, 2H), 2.56 (s, 3H), 2.50 (s, 3H) |
| CE.I.18. | CDCl₃: δ = 8.22 (d, 1H, J = 7.6 Hz), 7.93 (s, 1H), 7.71 (d, 1H, J = 2 Hz), |
| | 7.51 (d, 1H, J = 7.2 Hz), 7.46~7.44 (m, 1H), 7.15 (d, 1H, |
| | J = 10 Hz), 3.34~3.27 (m, 2H), 2.5 (s, 3H) |
| CE.I.19. | CDCl₃: δ = 8.33 (s, 1H), 8.27 (d, 1H, J = 8.8 Hz), 8.10 (d, 1H, J = 7.6 Hz), |
| | 7.80 (d, 1H, J = 2 Hz), 7.64~7.62 (m, 1H), 7.45 (d, 1H, J = 10.4 Hz), |
| | 4.02~3.89 (m, 2H), 2.53 (s, 3H) |
| CE.I.20. | CDCl₃: δ = 7.92 (d, 1H, J = 1.2 Hz), 7.92~7.72 (m, 2H), 7.60 (d, |
| | 1H, J = 7.2 Hz), 7.44~7.41 (m, 1H), 7.28 (s, 1H), 7.23 (d, 1H, J = 10.4 Hz), |
| | 3.95 (s, 3H), 3.43~3.36 (m, 2H), 2.58 (s, 3H) |
| CE.I.21. | CDCl₃: δ = 8.10 (d, 1H, J = 7.2 Hz), 7.93 (s, 1H), 7.75~7.07 (m, |
| | 2H), 7.45~7.42 (m, 1H), 7.27 (d, 1H, J = 8.8 Hz), 3.95 (s, 3H), |
| | 3.57~3.50 (m, 2H), 2.51 (s, 3H) |
| CE.I.22. | CDCl₃: δ = 7.95 (s, 1H), 7.67~7.61 (m, 2H), 7.57 (d, 1H, J = 7.2 Hz), |
| | 7.32 (d, 1H, J = 7.2 Hz), 7.20 (d, 1H, J = 10.4 Hz), |
| | 3.41~3.34 (m, 2H), 2.87 (s, 3H), 2.56 (s, 3H) |
| CE.I.23. | CDCl₃: δ = 8.07~8.05 (m 1H), 7.95 (d, 1H, J = 0.8 Hz), |
| | 7.69~7.61 (m, 2H), 7.34~7.32 (m, 1H), 7.25~7.23 (m, 1H), |
| | 3.56~3.45 (m, 2H), 2.87 (s, 3H) 2.48 (s, 3H) |
| CE.I.24. | CDCl₃: δ = 8.14 (s, 1H), 7.94 (s, 1H), 7.69~7.62 (m, 2H), 7.58 (d, |
| | 1H, J = 7.6 Hz), 7.21 (d, 1H, J = 10 Hz), 3.41~3.34 (m, 2H), |
| | 2.56 (s, 3H), 2.52 (s, 3H) |
| CE.I.25. | CDCl₃: δ = 8.25 (s, 1H), 8.14 (d, 2H, J = 7.2 Hz), 7.74~7.76 (m, |
| | 1H), 7.70~7.68 (m, 1H), 7.46~7.43 (m, 1H), 4.06~3.88 (m, 2H), |
| | 2.53 (s, 6H) |
| CE.I.26. | CDCl₃: δ = 7.99 (d, 1H, J = 0.8 Hz), 7.67~7.66 (m, 2H), |
| | 7.61~7.56 (m, 2H), 7.22 (d, 1H, J = 10 Hz), 3.43~3.35 (m, 2H), |
| | 2.58 (s, 3H) |
| CE.I.27. | CDCl₃: δ = 8.07 (d, 1H, J = 7.2 Hz), 7.98 (d, 1H, J = 0.8 Hz), |
| | 7.70~7.69 (m, 2H), 7.59~7.56 (m, 1H), 7.25~7.23 (m, 1H), |
| | 2.49 (s, 3H) |
| CE.I.28. | 3.62 min/365.05 |
| CE.I.29. | 2.75 min/380.90 |
| CE.I.30. | ¹H NMR (400 MHz, DMSO-d6): δ 8.40 (s, 1 H), 7.94-7.80 (m, |
| | 4H), 7.49 (d, J = 10.5 Hz, 1H), 4.04 (q, J_{H-F} = 10.2 Hz, 2H), |
| | 2.49 (s, 3H) |
| CE.I.31. | ¹H NMR (400 MHz, DMSO-d6): δ 8.41 (s, 1 H), 8.13 (d, J = 7.4 Hz, |
| | 1H), 7.94-7.86 (m, 2H), 7.85-7.79 (m, 1H), 7.58 (d, J = 10.7 Hz, |
| | 1H), 4.28-4.02 (m, 2H), 2.50 (s, 3H) |
| CE.I.32. | ¹H NMR (400 MHz, CDCl₃): δ 8.13 (s, 1H), 8.00 (s, 1H), 7.79 (d, |
| | J = 9.2 Hz, 1H), 7.65-7.60 (m, 2H), 7.20 (d, J = 10.1 Hz, 1H), |
| | 3.40 (q, J_{H-F} = 9.4 Hz, 2H), 2.55 (s, 3H) |
| CE.I.33. | ¹H NMR (400 MHz, DMSO-d6): δ 8.50 (s, 1 H), 8.16 (d, J = 7.4 Hz, |
| | 1H), 8.06 (broad s, 1H), 7.94 (broad s, 2H), 7.61 (d, J = 10.7 Hz, |
| | 1H), 4.33-4.02 (m, 2H), 2.50 (s, 3H). |
| CE.I.34. | ¹H NMR (400 MHz, CDCl₃): δ = 8.28-8.31 (m, 1H), 7.94 (s, 1H), |
| | 7.71-7.78 (m, 2H), 7.48-7.53 (m, 2H), 7.13-7.16 (m, 1H), |
| | 3.27-3.34 (m, 2H), 2.50 (s, 3H). |
| CE.I.35. | ¹H NMR (400 MHz, CDCl₃): δ = 8.34-8.36 (m, 1H), 8.08 (d, 1H, J = 7.2 Hz), |
| | 8.02 (s, 1H), 7.48-7.53 (m, 2H), 7.79-7.87 (m, 2H), |
| | 7.56-7.6 (m, 1H), 7.24-7.26 (m, 1H), 3.47-3.55 (m, 2H), 2.49 (s, |
| | 3H). |

### S. Synthesis Examples

### S.1 6-Fluoro-3-[2-fluoro-4-methyl-5-2(2,2,2-trifluoroethylsulfanyl)-phenyl]-3H-quinazolin-4-one

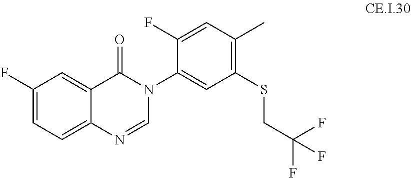 [SMILES: Cc1cc(F)c(-n2cnc3ccc(F)cc3c2=O)cc1SCC(F)(F)F]

### 1.1 3-Acetamino-4-fluoro-6-methyl-phenylsulfonyl chloride

To a solution of 2-fluoro-4-methyl-aniline (250 g, 2 mol) and triethylamine (202 g, 2 mol) in 2 L of dichloromethane was added dropwise acetyl chloride (156 g, 2 mol). The reaction mixture was stirred for 2 hours at a temperature of 0° C. and subsequently washed with dilute hydrochloric acid. The organic phase was dried with sodium sulfate and concentrated under reduced pressure to yield 2-fluoro-4-methyl-acetanilide as a crude intermediate (334 g, 87%).

To 546 g (3.27 mol) of crude 2-fluoro-4-methyl-acetanilide was added chlorosulphonic acid (2000 g, 17.24 mol) with stirring at a temperature below 70° C. Stirring was continued for 3 hours at a temperature of 70° C. The reaction mixture was poured onto ice and then extracted with ethyl acetate. The organic phase was dried with sodium sulfate and concentrated under reduced pressure to yield the title compound (500 g, 57.8%).

¹H NMR (400 MHz, CDCl₃): δ=9.1 (d, 1H, J=7.2 Hz), 7.39-7.52 (m, 1H), 7.14 (d, 1H, J=11.2 Hz), 2.72-2.78 (m, 3H), 2.2-2.3 (m, 3H).

### 1.2 3-(2,2,2-Trifluoroethylsulfanyl)-4-methyl-6-fluoroaniline

3-Acetamino-4-fluoro-6-methyl-phenylsulfonylchloride (500 g, 1.89 mol) was dissolved in 2 L of acetic acid. Red phosphorus (100 g, 3.22 mmol) and iodine (10 g, 39 mmol) were added to the solution, and the mixture was refluxed for 3 hours. The acetic acid was removed under reduced pressure, water was added and the residue extracted with ethyl acetate. The organic phase was dried with sodium sulfate and concentrated under reduced pressure to give 5-acetamino-4-fluoro-2-methyl-benzenethiol as a crude intermediate (270 g, 72%).

Crude 5-acetamino-4-fluoro-2-methyl-benzenethiol (280 g, 1.41 mol) was added to a 5% (w/w) solution of potassium hydroxide (250 g, 4.46 mol) in water and the mixture was refluxed for 5 hours. The resulting solution was adjusted to pH 7 with dilute hydrochloric acid and was then extracted with ethyl acetate. The organic phase was dried with sodium sulfate and concentrated under reduced pressure to give 5-amino-4-fluoro-2-methyl-benzenethiol as a crude intermediate (160 g, 88%).

¹H NMR (400 MHz, CDCl₃): δ=7.18 (d, 1H, J=1.6 Hz), 6.66-6.74 (m, 2H), 3.2-3.67 (m, 2H), 3.03-3.14 (m, 1H), 2.10-2.15 (m, 3H).

To a solution of potassium hydroxide (78.5 g, 1.4 mol), sodium hydroxymethylsulfinate (Rongalite®, 74.4 g, 0.63 mol) and the crude 5-amino-4-fluoro-2-methyl-benzenethiol (110 g, 0.7 mol) in 380 mL of DMF was added dropwise 2,2,2-trifluoroethyl iodide (147.1 g, 0.704 mol). The reaction mixture was stirred for 2 hours at room temperature, poured into water and then extracted with ethyl acetate. The organic phase was dried with sodium sulfate and concentrated under reduced pressure to yield the title compound (176 g, 99%).

¹H NMR (400 MHz, CDCl3): δ=6.84-6.89 (m, 1H), 6.7-6.78 (m 1H), 3.4-3.7 (m, 3H), 3.14-3.25 (m, 2H), 2.22-2.26 (m, 3H).

### 1.3 N-(2-Nitro-5-fluoro-benzoyl)-3-(2,2,2-trifluoroethylsulfanyl)-4-methyl-6-fluoro-anilide

To a solution of 3-(2,2,2-trifluoroethylsulfanyl)-4-methyl-6-fluoro-aniline (4.0 g, 16.7 mmol) in 100 mL DMF was added 2-Nitro-5-fluorobenzoic acid (3.09 g, 16.7 mmol), triethylamine (2.02 g, 20 mmol) and HATU (7.6 g, 20 mmol) and the resulting mixture was stirred overnight at room temperature. Water (300 mL) was then added and the reaction mixture was extracted with ethyl acetate (3×100 mL). The organic phase was washed with water (100 mL) and brine (100 mL), dried over magnesium sulfate, filtered and concentrated under reduced pressure. The crude product was purified by column chromatography on silica gel eluting with a gradient of ethyl acetate/cyclohexane to afford the title compound (5.00 g, 74%) as a yellow solid.

### 1.4 N-(2-amino-5-fluoro-benzoyl)-3-(2,2,2-trifluoroethylsulfanyl)-4-methyl-6-fluoro-anilide

To a suspension of N-(2-nitro-5-fluoro-benzoyl)-3-(2,2,2-trifluoroethylsulfanyl)-4-methyl-6-fluoro-anilide (5.0 g, 12.3 mmol) in 87 mL ethanol was added Raney nickel (1.0 g) and the stirred mixture was hydrogenated at ambient pressure overnight at room temperature. The solid was filtered off and the filtrate was evaporated to give the intermediate N-(2-amino-5-fluoro-benzoyl)-3-(2,2,2-trifluoroethylsulfanyl)-4-methyl-6-fluoro-anilide (4.6 g, 99%) as a white solid.

### 1.5 6-Fluoro-3-[2-fluoro-4-methyl-5-2(2,2,2-trifluoroethylsulfanyl)-phenyl]-3H-quinazolin-4-one

A mixture of N-(2-amino-5-fluoro-benzoyl)-3-(2,2,2-trifluoroethylsulfanyl)-4-methyl-6-fluoro-anilide (4.0 g, 10.6 mmol), concentrated sulfuric acid (0.24 mL, 4.5 mmol) and 1,1,1-triethoxymethane (23 g) were heated to 140° C. and stirred for 3 hours at this temperature. The mixture was cooled to room temperature, excess of solvent was removed under reduced pressure and the crude product was purified by column chromatography on silica gel eluting with a gradient of ethyl acetate/cyclohexane to afford the title compound I-1 (1.8 g, 44%) as a white solid.

¹H NMR (400 MHz, DMSO-d6): δ 8.40 (s, 1H), 7.94-7.80 (m, 4H), 7.49 (d, J=10.5 Hz, 1H), 4.04 (q, =10.2 Hz, 2H), 2.49 (s, 3H)

### S.2 6-Fluoro-3-[2-fluoro-4-methyl-5-2(2,2,2-trifluoroethanesulfinyl)-phenyl]-3H-quinazolin-4-one

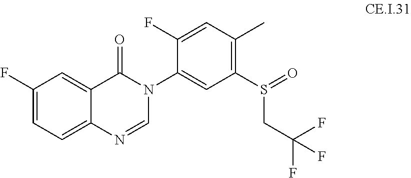 [SMILES: Cc1cc(F)c(-n2cnc3ccc(F)cc3c2=O)cc1S(=O)CC(F)(F)F]

To a solution of 6-fluoro-3-[2-fluoro-4-methyl-5-2(2,2,2-trifluoroethylsulfanyl)-phenyl]-3H-quinazolin-4-one I-1 (1.0 g, 2.59 mmol) in 100 mL chloroform at 0° C. was added m-chloroperoxybenzoic acid (m-CPBA) (0.58 g, 2.59 mmol, 77% purity) and the reaction mixture was stirred for 3 hours at 0° C. The reaction mixture was then washed with a saturated solution of sodium thiosulfate (100 mL) and a saturated solution of sodium hydrogencarbonate (100 mL). The organic phase was separated, dried over magnesium sulfate, filtered and concentrated under reduced pressure. Recrystallization from hot ethanol afforded the title compound I-2 (0.76 g, 73%) as a white solid.

¹H NMR (400 MHz, DMSO-d6): δ 8.41 (s, 1H), 8.13 (d, J=7.4 Hz, 1H), 7.94-7.86 (m, 2H), 7.85-7.79 (m, 1H), 7.58 (d, J=10.7 Hz, 1H), 4.28-4.02 (m, 2H), 2.50 (s, 3H)

### S.3 6-Trifluoromethoxy-3-[2-fluoro-4-methyl-5-2(2,2,2-trifluoroethylsulfanyl)-phenyl]-3H-quinazolin-4-one

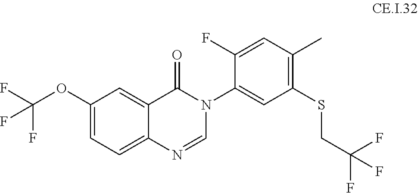 [SMILES: Cc1cc(F)c(-n2cnc3ccc(OC(F)(F)F)cc3c2=O)cc1SCC(F)(F)F]

### 3.1 N-(2-Nitro-5-trifluormethoxy-benzoyl)-3-(2,2,2-trifluoroethylsulfanyl)-4-methyl-6-fluoro-anilide

To a solution of 3-(2,2,2-trifluoroethylsulfanyl)-4-methyl-6-fluoro-aniline (3.0 g, 12.5 mmol) in 75 mL DMF was added 2-nitro-5-trifluoromethoxybenzoic acid (3.15 g, 12.5 mmol), triethylamine (1.5 g, 15 mmol) and HATU (5.7 g, 15 mmol) and the resulting mixture was stirred overnight at room temperature. Water (300 mL) was then added and the reaction mixture was extracted with ethyl acetate (3×100 mL). The organic phase was washed with water (100 mL) and brine (100 mL), dried over magnesium sulfate, filtered and concentrated under reduced pressure. The crude product was purified by column chromatography on silica gel eluting with a gradient of ethyl acetate/cyclohexane to afford the title compound (4.10 g, 69%) as a yellow solid.

### 3.2 N-(2-amino-5-trifluormethoxy-benzoyl)-3-(2,2,2-trifluoroethylsulfanyl)-4-methyl-6-fluoro-anilide

To a suspension of N-(2-nitro-5-trifluormethoxy-benzoyl)-3-(2,2,2-trifluoroethylsulfanyl)-4-methyl-6-fluoro-anilide (4.1 g, 8.7 mmol) in 61 mL ethanol was added Raney nickel (1.0 g) and the stirred mixture was hydrogenated at ambient pressure overnight at room temperature. The solid was filtered off and the filtrate was evaporated to give the intermediate N-(2-amino-5-fluoro-benzoyl)-3-(2,2,2-trifluoroethylsulfanyl)-4-methyl-6-fluoro-anilide (3.0 g, 78%) as a white solid.

### 3.3 6-Trifluoromethoxy-3-[2-fluoro-4-methyl-5-2(2,2,2-trifluoroethylsulfanyl)-phenyl]-3H-quinazolin-4-one

A mixture of N-(2-amino-5-trifluoromethoxy-benzoyl)-3-(2,2,2-trifluoroethylsulfanyl)-4-methyl-6-fluoro-anilide (3.0 g, 6.8 mmol), concentrated sulfuric acid (0.15 mL, 2.8 mmol) and 1,1,1-triethoxymethane (15 g) were heated to 140° C. and stirred for 3 hours at this temperature. The mixture was cooled to room temperature, excess of solvent was removed under reduced pressure and the crude product was purified by column chromatography on silica gel eluting with a gradient of ethyl acetate/cyclohexane to afford the title compound I-3 (1.8 g, 59%) as a white solid.

¹H NMR (400 MHz, CDCl₃): δ 8.13 (s, 1H), 8.00 (s, 1H), 7.79 (d, J=9.2 Hz, 1H), 7.65-7.60 (m, 2H), 7.20 (d, J=10.1 Hz, 1H), 3.40 (q, J_{H-F}=9.4 Hz, 2H), 2.55 (s, 3H)

### S.4 6-Trifluormethoxy-3-[2-fluoro-4-methyl-5-2(2,2,2-trifluoroethanesulfinyl)-phenyl]-3H-quinazolin-4-one

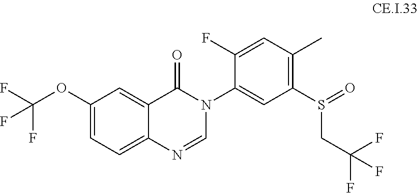 [SMILES: Cc1cc(F)c(-n2cnc3ccc(OC(F)(F)F)cc3c2=O)cc1S(=O)CC(F)(F)F]

To a solution of 6-trifluoromethoxy-3-[2-fluoro-4-methyl-5-2(2,2,2-trifluoroethylsulfanyl)-phenyl]-3H-quinazolin-4-one I-3 (1.5 g, 3.32 mmol) in 128 mL chloroform at 0° C. was added m-chloroperoxybenzoic acid (m-CPBA) (0.74 g, 3.32 mmol, 77% purity) and the reaction mixture was stirred for 3 hours at 0° C. The reaction mixture was then washed with a saturated solution of sodium thiosulfate (100 mL) and a saturated solution of sodium hydrogencarbonate (100 mL). The organic phase was separated, dried over magnesium sulfate, filtered and concentrated under reduced pressure. Recrystallization from hot ethanol afforded the title compound I-4 (0.4 g, 26%) as a white solid.

¹H NMR (400 MHz, DMSO-d6): δ 8.50 (s, 1H), 8.16 (d, J=7.4 Hz, 1H), 8.06 (broad s, 1H), 7.94 (broad s, 2H), 7.61 (d, J=10.7 Hz, 1H), 4.33-4.02 (m, 2H), 2.50 (s, 3H).

### S.5 2-(2,2,2-trifluoroethylsufanyl)-4-(4-oxo-quinazolin-3-yl)-5-fluoro-toluol

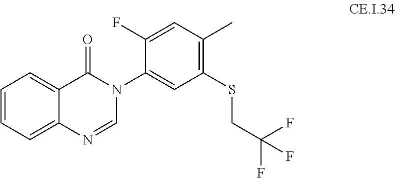 [SMILES: Cc1cc(F)c(-n2cnc3ccccc3c2=O)cc1SCC(F)(F)F]

### 5.1 3-Acetamino-4-fluoro-6-methyl-phenylsulfonylchloride

To a solution of 2-fluoro-4-methyl-aniline (250 g, 2 mol) and triethylamine (202 g, 2 mol) in 2 L of dichloromethane was added dropwise acetylchloride (156 g, 2 mol). The reaction mixture was stirred for 2 hours at a temperature of 0° C. and subsequently washed with dilute hydrochloric acid. The organic phase was dried with sodium sulfate and concentrated under reduced pressure to yield 2-fluoro-4-methyl-acetanilide as a crude intermediate (334 g, 87%).

To 546 g (3.27 mol) of crude 2-fluoro-4-methyl-acetanilide was added chlorosulphonic acid (2000 g, 17.24 mol) with stirring at a temperature below 70° C. Stirring was continued for 3 hours at a temperature of 70° C. The reaction mixture was poured onto ice and then extracted with ethyl acetate. The organic phase was dried with sodium sulfate and concentrated under reduced pressure to yield the title compound (500 g, 57.8%).

¹H NMR (400 MHz, CDCl₃): δ=9.1 (d, 1H, J=7.2 Hz), 7.39-7.52 (m, 1H), 7.14 (d, 1H, J=11.2 Hz), 2.72-2.78 (m, 3H), 2.2-2.3 (m, 3H).

### 5.2 3-(2,2,2-Trifluoroethylsulfanyl)-4-methyl-6-fluoro-aniline

3-Acetamino-4-fluoro-6-methyl-phenylsulfonylchloride (500 g, 1.89 mol) was dissolved in 2 L of acetic acid. Red phosphorus (100 g, 3.22 mmol) and iodine (10 g, 39 mmol) were added to the solution, and the mixture was refluxed for 3 hours. The acetic acid was removed under reduced pressure, water was added and the residue extracted with ethyl acetate. The organic phase was dried with sodium sulfate and concentrated under reduced pressure to give 5-acetamino-4-fluoro-2-methyl-benzenethiol as a crude intermediate (270 g, 72%).

Crude 5-acetamino-4-fluoro-2-methyl-benzenethiol (280 g, 1.41 mol) was added to a 5% (w/w) solution of potassium hydroxide (250 g, 4.46 mol) in water and the mixture was refluxed for 5 hours. The resulting solution was adjusted to pH 7 with dilute hydrochloric acid and was then extracted with ethyl acetate. The organic phase was dried with sodium sulfate and concentrated under reduced pressure to give 5-amino-4-fluoro-2-methyl-benzenethiol as a crude intermediate (160 g, 88%).

¹H NMR (400 MHz, CDCl₃): δ=7.18 (d, 1H, J=1.6 Hz), 6.66-6.74 (m, 2H), 3.2-3.67 (m, 2H), 3.03-3.14 (m, 1H), 2.10-2.15 (m, 3H).

To a solution of potassium hydroxide (78.5 g, 1.4 mol), sodium hydroxymethylsulfinate (Rongalite®, 74.4 g, 0.63 mol) and the crude 5-amino-4-fluoro-2-methyl-benzenethiol (110 g, 0.7 mol) in 380 mL of DMF was added dropwise 2,2,2-trifluoroethyl iodide (147.1 g, 0.704 mol). The reaction mixture was stirred for 2 hours at room temperature, poured into water and then extracted with ethyl acetate. The organic phase was dried with sodium sulfate and concentrated under reduced pressure to yield the title compound (176 g, 99%).

¹H NMR (400 MHz, CDCl₃): δ=6.84-6.89 (m, 1H), 6.7-6.78 (m 1H), 3.4-3.7 (m, 3H), 3.14-3.25 (m, 2H), 2.22-2.26 (m, 3H).

### 5.3 N-(2-Nitro-benzoyl)-3-(2,2,2-trifluoroethylsulfanyl)-4-methyl-6-fluoro-anilide

3-(2,2,2-Trifluoroethylsulfanyl)-4-methyl-6-fluoro-aniline (4.0 g, 16.7 mmol) was dissolved in 100 mL DMF. 2-Nitrobenzoic acid (2.79 g, 16.7 mmol) and triethylamine (2.02 g, 20 mmol) were added to the solution. After cooling to a temperature of 0° C. HATU (7.62 g, 20 mmol) was added in one portion and the resulting mixture was stirred overnight at room temperature. Water was added to the reaction mixture, which was then extracted with ethyl acetate. The organic phase was dried with sodium sulfate and the crude product was purified by column chromatography on silica gel to give the title compound (5 g, 76.9%) as a yellow solid.

¹H NMR (400 MHz, CDCl₃): δ=8.6 (d, 1H, J=7.6 Hz), 8.2 (d, 1H, J=8 Hz), 7.73-7.76 (m, 1H), 7.61-7.67 (m, 3H), 7.0 (s, 1H), 3.39-3.46 (m, 2H), 2.45 (s, 3H).

### 5.4 2-(2,2,2-trifluoroethylsulfanyl)-4-(4-oxo-quinazolin-3-yl)-5-fluoro-toluol

To a suspension of N-(2-nitro-benzoyl)-3-(2,2,2-trifluoroethylsulfanyl)-4-methyl-6-fluoro-anilide (2.3 g, 5.9 mmol) in 230 mL ethanol was added Raney nickel (0.8 g) and the stirred mixture was hydrogenated at ambient pressure overnight at room temperature. The solid was filtered off and the filtrate was evaporated to give the intermediate N-(2-amino-benzoyl)-3-(2,2,2-trifluoroethylsulfanyl)-4-methyl-6-fluoro-anilide (2 g, 95%) as a white solid.

¹H NMR (400 MHz, DMSO-d₆): δ=9.79 (s, 1H), 7.75-7.71 (m, 2H), 7.16-7.24 (m, 2H), 6.72 (d, 1H, J=8.4 Hz), 6.55 (t, 1H, J=7.4 Hz), 6.44 (s, 2H), 3.79-3.87 (m, 2H), 2.38 (s, 3H).

A mixture of the amine N-(2-amino-benzoyl)-3-(2,2,2-trifluoroethylsulfanyl)-4-methyl-6-fluoro-anilide (2.3 g, 6.4 mmol), concentrated sulfuric acid (2 mL) and 1,1,1-triethoxymethane (100 mL) were heated to 140° C. and stirred for 5 hours at this temperature. The mixture was cooled to room temperature, excess of solvent was removed under reduced pressure and the crude product was purified by column chromatography on silica gel to yield the title compound (1.4 g, 59%) as an off-white solid.

Melting point: 145-147° C.

### S.6 2-(2,2,2-trifluoroethylsufinyl)-4-(4-oxo-quinazolin-3-yl)-5-fluoro-toluol

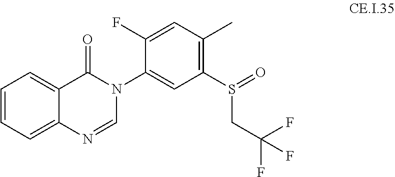 [SMILES: Cc1cc(F)c(-n2cnc3ccccc3c2=O)cc1S(=O)CC(F)(F)F]

2-(2,2,2-Trifluoroethylsulfanyl)-4-(4-oxo-quinazolin-3-yl)-5-fluoro-toluol (0.80 g, 1.96 mmol) was dissolved in 20 mL chloroform and meta-chloroperoxybenzoic acid (0.466 g, 2.29 mmol, 85% of purity) was added under ice-cooling. The reaction mixture was stirred for 1 hour at ice bath temperature. The solution was washed successively with an aqueous solution of sodiumthiosulfate and an aqueous solution of sodiumhydrogencarbonate, and dried with sodium sulfate. After removing excess solvent under reduced pressure the crude product was purified by column chromatography on silica gel to give the title compound (0.32 g, 42.9%) as an off-white solid.

Melting point: 184-186° C.

### B. Biology

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 20-22):

$$E = X + Y - \frac{XY}{100}$$

When the observed combined control effect is greater than the expected combined control effect (E), then the combined effect is synergistic.

The analysis of synergism or antagonism between the mixtures or compositions was determined using Colby's equation.

### B.1 Pesticidal Activity Against Animal Pests

The following tests can demonstrate the control efficacy of compounds, mixtures or compositions of this invention on specific pests. However, the pest control protection afforded by the compounds, mixtures or compositions is not limited to these species. In certain instances, combinations of a compound of this invention with other invertebrate pest control compounds or agents are found to exhibit synergistic effects against certain important invertebrate pests.

### Insecticidal Test Example B.1.1

For evaluating e.g. the control of vetch aphid (Megoura viciae) through contact or systemic means the test unit consists of 24-well-microtiter plates containing broad bean leaf disks.

The compounds or mixtures are formulated using a solution containing 75% water and 25% DMSO. Different concentrations of formulated compounds or mixtures are sprayed onto the leaf disks at 2.5 μl, using a custom built micro atomizer, at two replications.

For experimental mixtures in these tests identical volumes of both mixing partners at the desired concentrations respectively, are mixed together.

After application, the leaf disks are air-dried and 5-8 adult aphids placed on the leaf disks inside the microtiter plate wells. The aphids are then allowed to suck on the treated leaf disks and incubated at about 23±1° C. and about 50±5% RH (relative humidity) for 5 days. Aphid mortality and fecundity is visually assessed.

### Insecticidal Test Example B.1.2

For evaluating e.g. the control of bird cherry aphid (Rhopalosiphum padi) through contact or systemic means the test unit consists of 96-well-microtiter plates containing barley leaf disks.

The compounds or mixtures are formulated using a solution containing 75% water and 25% DMSO. Different concentrations of formulated compounds or mixtures are sprayed onto the leaf disks at 2.5 μl, using a custom built micro atomizer, at two replications.

For experimental mixtures in these tests identical volumes of both mixing partners at the desired concentrations respectively, are mixed together.

After application, the leaf disks are air-dried and 5-8 adult aphids placed on the leaf disks inside the microtiter plate wells. The aphids are then allowed to suck on the treated leaf disks and incubated at about 25±1° C. and about 80±5% RH for 3 to 5 days. Aphid mortality and fecundity is visually assessed.

### Insecticidal Test Example B.1.3

For evaluating e.g. the control of green peach aphid (Myzus persicae) through systemic means the test unit consists of 96-well-microtiter plates containing liquid artificial diet under an artificial membrane.

The compounds or mixtures are formulated using a solution containing 75% water and 25% DMSO. Different concentrations of formulated compounds or mixtures are pipetted into the aphid diet, using a custom built pipetter, at two replications.

For experimental mixtures in these tests identical volumes of both mixing partners at the desired concentrations respectively, are mixed together.

After application, 5-8 adult aphids are placed on the artificial membrane inside the microtiter plate wells. The aphids are then allowed to suck on the treated aphid diet and incubated at about 23±1° C. and about 50±5% RH for 3 days. Aphid mortality and fecundity is visually assessed.

### Insecticidal Test Example B.1.4

For evaluating e.g. control of boll weevil (Anthonomus grandis) the test unit consists of 24-well-microtiter plates containing an insect diet and 20-30 A. grandis eggs.

The compounds or mixtures are formulated using a solution containing 75% water and 25% DMSO. Different concentrations of formulated compounds or mixtures are sprayed onto the insect diet at 20 μl, using a custom built micro atomizer, at two replications.

For experimental mixtures in these tests identical volumes of both mixing partners at the desired concentrations respectively, are mixed together.

After application, microtiter plates are incubated at about 23±1° C. and about 50±5% RH for 5 days. Egg and larval mortality is visually assessed.

### Insecticidal Test Example B.1.5

For evaluating e.g. control of Mediterranean fruitfly (Ceratitis capitata) the test unit consists of 96-well-microtiter plates containing an insect diet and 50-80 C. capitata eggs. The compounds or mixtures are formulated using a solution containing 75% water and 25% DMSO. Different concentrations of formulated compounds or mixtures are sprayed onto the insect diet at 5 μl, using a custom built micro atomizer, at two replications.

For experimental mixtures in these tests identical volumes of both mixing partners at the desired concentrations respectively, are mixed together.

After application, microtiter plates are incubated at about 28±1° C. and about 80±5% RH for 5 days. Egg and larval mortality is then visually assessed.

### Insecticidal Test Example B.1.6

For evaluating e.g. control of tobacco budworm (Heliothis virescens) the test unit consists of 96-well-microtiter plates containing an insect diet and 15-25 H. virescens eggs. The compounds or mixtures are formulated using a solution containing 75% water and 25% DMSO. Different concentrations of formulated compounds or mixtures are sprayed onto the insect diet at 10 μl, using a custom built micro atomizer, at two replications.

For experimental mixtures in these tests identical volumes of both mixing partners at the desired concentrations respectively, are mixed together.

After application, microtiter plates are incubated at about 28±1° C. and about 80±5% RH for 5 days. Egg and larval mortality is visually assessed.

### B.2 Pesticidal Action Against Fungi

The fungicidal action of the mixtures of the prcompounds of the formula I by the following experiments:

The following tests can be used to demonstrate and evaluate the fungicidal action of compounds, mixtures or compositions of this invention on specific fungi. However, the fungicidal control protection afforded by the compounds, mixtures or compositions is not limited to these fungi. In certain instances, combinations of a compound of this invention with other fungicidal compounds or agents are found to exhibit synergistic effects against certain important fungi.

### B.2. Fungicidal Tests

If not otherwise specified. the active substances are formulated separately as a stock solution in dimethyl sulfoxide (DMSO) at a concentration of 10 000 ppm.

The measured parameters were compared to the growth of the active compound-free control variant (100%) and the fungus-free and active compound-free blank value to determine the relative growth in % of the pathogens in the respective active compounds. These percentages were converted into efficacies.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

### Fungicidal Test Example B.2.1

### Activity Against Wheat Leaf Spots Caused by Leptosphaeria nodorum (Leptno)

The stock solutions were mixed according to the ratio, pipetted onto a micro titer plate (MTP) and diluted with water to the stated concentrations. A spore suspension of Leptosphaeria nodorum in an aqueous biomalt or yeast-bactopeptone-glycerine solution was then added. The plates were placed in a water vapor-saturated chamber at a temperature of 18° C. Using an absorption photometer, the MTPs were measured at 405 nm 7 days after the inoculation.

| | | | | Calculated | |
|---|---|---|---|---|---|
| | | | | efficacy | |
| Active | Con- | | | according | |
| compound/ | centration | | Observed | to Colby | Synergism |
| active mixture | (ppm) | Mixture | efficacy | (%) | (%) |
| CE.I.31 | 63 | — | 19 | 57 | |
| Propineb | 4 | — | 57 | | |
| CE.I.31 | 63 | 16:1 | 94 | 65 | 29 |
| Propineb | 4 | | | | |

### Fungicidal Test Example B.2.2

### Activity Against Rice Blast by Pyricularia oryzae in the Microtiterplate Test (Pyrior)

The stock solutions were mixed according to the desired ratio, pipetted onto a micro titer plate (MTP) and diluted with water to the stated concentrations. A spore suspension of Pyricularia oryzae in an aqueous biomalt or yeast-bactopeptone-glycerine solution was then added. The plates were placed in a water vapor-saturated chamber at a temperature of 18° C. Using an absorption photometer, the MTPs were measured at 405 nm 7 days after the inoculation

Results:

| | | Ratio of | | Calculated | |
|---|---|---|---|---|---|
| | | compound | | efficacy | |
| Ratio of/active | | I to compound | | according | |
| compound(s)/in | Concentration | II in | Observed | to Colby | Synergism |
| active mixture | [ppm] | mixture | efficacy | (%) | (%) |
| CE.I.31 | 63 | — | 16 | | |
| | 4 | — | 11 | | |
| | 1 | — | 8 | | |
| Trifloxystrobin | 0.016 | — | 26 | | |
| Picoxystrobin | 0.016 | — | 19 | | |
| Pyraclostrobin | 0.004 | — | 32 | | |
| Boscalid | 16 | — | 8 | | |
| Carbendazim | 0.25 | — | 19 | | |
| Cyazofamid | 1 | — | 10 | | |
| Chlorothalonil | 0.25 | — | 30 | | |
| CE.I.31 | 4 | 250:1 | 60 | 34 | 26 |
| Trifloxystrobin | 0.016 | | | | |
| CE.I.31 | 1 | 63:1 | 44 | 26 | 18 |
| Picoxystrobin | 0.016 | | | | |
| CE.I.31 | 1 | 250:1 | 59 | 38 | 21 |
| Pyraclostrobin | 0.004 | | | | |
| CE.I.31 | 63 | 4:1 | 67 | 22 | 45 |
| Boscalid | 16 | | | | |
| CE.I.31 | 4 | 16:1 | 52 | 29 | 23 |
| Carbendazim | 0.25 | | | | |
| CE.I.31 | 63 | 63:1 | 54 | 25 | 29 |
| Cyazofamid | 1 | | | | |
| CE.I.31 | 4 | 16:1 | 100 | 38 | 62 |
| Chlorothalonil | 0.25 | | | | |

### Fungicidal Test Example B.2.3

### Activity Against Leaf Blotch on Wheat Caused by Septoria tritici(Septtr)

The stock solutions were mixed according to the ratio, pipetted onto a micro titer plate (MTP) and diluted with water to the stated concentrations. A spore suspension of Septoria tritici in an aqueous biomalt or yeast-bactopeptone-glycerine solution was then added. The plates were placed in a water vapor-saturated chamber at a temperature of 18° C. Using an absorption photometer, the MTPs were measured at 405 nm 7 days after the inoculation.

| | | Ratio of | | Calculated | |
|---|---|---|---|---|---|
| | | compound | | efficacy | |
| Ratio of/active | | I to compound | | according | |
| compound(s)/in | Concentration | II in | Observed | to Colby | Synergism |
| active mixture | [ppm] | mixture | efficacy | (%) | (%) |
| CE.I.31 | 63 | — | 19 | | |
| Fluoxastrobin | 0.25 | — | 58 | | |
| Fluxapyroxad | 0.063 | — | 58 | | |
| CE.I.31 | 63 | 250:1 | 97 | 66 | 31 |
| Fluoxastrobin | 0.25 | | | | |
| CE.I.31 | 63 | 1000:1 | 90 | 66 | 24 |
| Fluxapyroxad | 0.063 | | | | |

Further biological test, with which the fungicidal activity of mixtures according to the present invention can be evaluated are described below.

### Fungicidal Test Example B.2.4

### Activity Against the Grey Mold Botrytis cinerea in the Microtiterplate Test (Botrci)

The stock solutions are mixed according to the ratio, pipetted onto a micro titer plate (MTP) and diluted with water to the stated concentrations. A spore suspension of Botrci cinerea in an aqueous biomalt solution is added. The plates are placed in a water vapor-saturated chamber at a temperature of 18° C. Using an absorption photometer, the MTPs are measured at 405 nm 7 days after the inoculation.

### Fungicidal Test Example B.2.5

### Activity Against Early Blight Alternaria solani in the Microtiterplate Test (Alteso)

The stock solutions are mixed according to the ratio, pipetted onto a micro titer plate (MTP) and diluted with water to the stated concentrations. A spore suspension of Alternaria solani in an aqueous biomalt solution is added. The plates are placed in a water vapor-saturated chamber at a temperature of 18° C. Using an absorption photometer, the MTPs are measured at 405 nm 7 days after the inoculation.

### Fungicidal Test Example B.2.6

### Activity Against Septoria glycines in the Microtiterplate Test (Septgl)

The stock solutions are mixed according to the ratio, pipetted onto a micro titer plate (MTP) and diluted with water to the stated concentrations. A spore suspension of Septoria glycines in an aqueous biomalt solution is added. The plates are placed in a water vapor-saturated chamber at a temperature of 18° C. Using an absorption photometer, the MTPs are measured at 405 nm 7 days after the inoculation.

### Fungicidal Test Example B.2.7

### Activity Against Colletotrichum truncatum in the Microtiterplate Test (Colltr)

The stock solutions are mixed according to the ratio, pipetted onto a micro titer plate (MTP) and diluted with water to the stated concentrations. A spore suspension of Colleotrichum truncatum in an aqueous biomalt solution is added. The plates are placed in a water vapor-saturated chamber at a temperature of 18° C. Using an absorption photometer, the MTPs are measured at 405 nm 7 days after the inoculation.

### Fungicidal Test Example B.2.8

### Fungicidal Control of Brown Spot Caused by Cochliobolus miyabeanus (Protective)

Leaves of pot-grown rice seedlings are sprayed to run-off with an aqueous suspension containing a certain concentration of active ingredients prepared from a stock solution. The plants are allowed to air-dry. At the following day the plants are inoculated with an aqueous spore suspension of Cochliobolus miyabeanus. Then the trial plants are immediately to be transferred to a humid chamber. After 6 days at 22-24° C. and a relative humidity close to 100% the extent of fungal attack on the leaves is visually assessed as % diseased leaf area.

Also here, the measured parameters of the fungicidal tests are to be compared to the growth of the active compound-free control variant (100%) and the fungus-free and active compound-free blank value to determine the relative growth in % of the pathogens in the respective active compounds. These percentages are to be converted into efficacies. An efficacy of 0 means that the growth level of the pathogens corresponds to that of the untreated control; an efficacy of 100 means that the pathogens are not growing.

As explained above, the expected efficacies of active compound mixtures are to be determined using Colby's formula [R. S. Colby, “Calculating synergistic and antagonistic responses of herbicide combinations”, Weeds 15, 20-22 (1967)] and compared with the observed efficacies.

1-32. (canceled)

33. An agricultural mixture comprising as active compounds
1) at least one compound of formula (I): 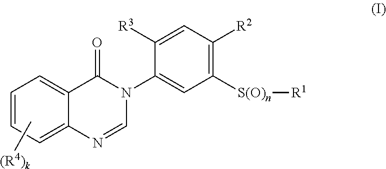
wherein
R¹ is C₁-C₄-alkyl, fluorinated C₁-C₄-alkyl, C₂-C₄-alkenyl, fluorinated C₂-C₄-alkenyl, cyclopropyl or cyclopropylmethyl;
R² is hydrogen, halogen, CN, C₁-C₄-alkyl or C₁-C₄-haloalkyl;
R³ is hydrogen, halogen, CN, C₁-C₄-alkyl or C₁-C₄-haloalkyl;
R⁴ is selected independently from the integer of k from the group consisting of halogen, CN, NO₂, C₁-C₄-alkyl, C₁-C₄-haloalkyl, C₂-C₄-alkenyl, C₁-C₄-haloalkenyl, C₂-C₄-alkynyl, C₁-C₄-haloalkynyl, C₁-C₄-alkoxy-C₁-C₄-alkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl and C₁-C₄-haloalkylsulfonyl;
k is 0, 1, 2, 3 or 4;
n is 0, 1 or 2;
or a tautomer, enantiomer, diastereomer or salt thereof,
and
2) at least one fungicidal active compound II selected from group F consisting of
F.I) a respiration inhibitor selected from the group consisting of
a) an Inhibitor of complex III at Qₒ site selected from the group consisting of azoxystrobin, coumethoxystrobin, coumoxystrobin, dimoxystrobin, enestroburin, fenaminstrobin, fenoxystrobin/flufenoxystrobin, fluoxastrobin, kresoxim-methyl, meto-minostrobin, orysastrobin, picoxy-strobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-di-chlorophenyl)-1-methylallylidene-aminooxy-methyl)-phenyl)-2-methoxyimino-N-methyl-acetamide, pyribencarb, triclopyricarb/chlorodincarb, famoxadone, and fenamidone;
b) an inhibitor of complex III at Qᵢ site selected from the group consisting of cyazofamid and amisulbrom;
c) an inhibitor of complex II selected from the group consisting of benodanil, bixafen, boscalid, carboxin, fen-furam, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide and N-(2-(1,3,3-trimethylbutyl)-phenyl)-1,3-dimethyl-5-fluoro-1H-pyrazole-4-carboxamide;
d) another respiration inhibitor selected from the group consisting of diflumetorim; nitrophenyl derivates: binapacryl, dinobuton, dinocap, fluazinam; ferimzone; organometal compounds: fentin salts, such as fentin-acetate, fentin chloride or fentin hydroxide; ametoctradin; and silthiofam;
F.II) a sterol biosynthesis inhibitor (SBI fungicides) selected from the group consisting of
a) a C14 demethylase inhibitor selected from the group consisting of triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothio-conazole, simeconazole, tebuconazole, tetraconazole, triadimefon, triadimenol, triticonazole, uniconazole; imidazoles: imazalil, pefurazoate, prochloraz, triflumizol; pyrimidines, pyridines and piperazines: fenarimol, nuarimol, pyrifenox, and triforine;
b) a delta14-reductase inhibitor selected from the group consisting of aldimorph, dodemorph, dodemorph-acetate, fenpropimorph, tridemorph, fenpropidin, piperalin, and spiroxamine;
c) an inhibitor of 3-keto reductase fenhexamid;
F.III) a nucleic acid synthesis inhibitor selected from
a) a phenylamide or an acyl amino acid fungicide selected from the group consisting of benalaxyl, benalaxyl-M, kiralaxyl, metalaxyl, metalaxyl-M (mefenoxam), ofurace, and oxadixyl;
b) another selected from the group consisting of hymexazole, octhilinone, oxolinic acid, and bupirimate;
F.IV) an inhibitor of cell division and cytoskeleton selected from
a) a tubulin inhibitor selected from the group consisting of benzimidazoles, thiophanates: benomyl, carbendazim, fuberidazole, thiabendazole, thiophanatemethyl; triazolopyrimidines: 5-chloro-7-(4-methyl-piperidin-1-yl)-6-(2,4,6-trifluorophenyl)-[1,2,4]triazolo[1,5-a]pyrimidine
b) other cell division inhibitor selected from the group consisting of diethofencarb, ethaboxam, pencycuron, fluopicolide, zoxamide, metrafenone, and pyriofenone;
F.V) an inhibitor of amino acid and protein synthesis selected from
a) a methionine synthesis inhibitor selected from the group consisting of cyprodinil, mepanipyrim, and pyrimethanil;
b) a protein synthesis inhibitor selected from the group consisting of blasticidin-S, kasugamycin, kasugamycin hydrochloride-hydrate, mildiomycin, streptomycin, oxytetracyclin, polyoxine, and validamycin A;
F.VI) a signal transduction inhibitor selected from
a) an MAP/histidine kinase inhibitor selected from the group consisting of fluoroimid, iprodione, procymidone, vinclozolin, fenpiclonil, and fludioxonil;
b) G protein inhibitor quinoxyfen;
F.VII) a lipid and membrane synthesis inhibitor selected from
a) a phospholipid biosynthesis inhibitor selected from the group consisting of edifenphos, iprobenfos, pyrazophos, and isoprothiolane;
b) a lipid peroxidation selected from the group consisting of dicloran, quintozene, tecnazene, tolclofos-methyl, biphenyl, chloroneb, and etridiazole;
c) a phospholipid biosynthesis and cell wall deposition selected from the group consisting of dimethomorph, flumorph, mandipropamid, pyrimorph, benthiavalicarb, iprovalicarb, valifenalate and N-(1-(1-(4-cyanophenyl)-ethanesulfonyl)-but-2-yl)carbamic acid-(4-fluorophenyl)ester;
d) compounds affecting cell membrane permeability and fatty acids: propamocarb, propamocarb-hydrochlorid;
F.VIII) an inhibitor with Multi Site Action selected from
a) an inorganic active substance selected from the group consisting of Bordeaux mixture, copper acetate, copper hydroxide, copper oxychloride, basic copper sulfate, and sulfur;
b) a thio- and dithiocarbamate selected from the group consisting of ferbam, mancozeb, maneb, metam, metiram, propineb, thiram, zineb, and ziram;
c) an organochlorine compound selected from the group consisting of anilazine, chlorothalonil, captafol, captan, folpet, dichlofluanid, dichlorophen, flusulfamide, hexachlorobenzene, pentachlorphenole and its salts, phthalide, tolylfluanid, and N-(4-chloro-2-nitro-phenyl)-N-ethyl-4-methyl-benzenesulfonamide;
d) a guanidine and other compounds selected from the group consisting of guanidine, dodine, dodine free base, guazatine, guazatine-acetate, iminoctadine, iminoctadine-triacetate, iminoctadine-tris(albesilate), and dithianon;
F.IX) a cell wall synthesis inhibitor selected from
an inhibitor of glucan synthesis selected from the group consisting of validamycin, polyoxin B; melanin synthesis inhibitor selected from the group consisting of pyroquilon, tricyclazole, carpropamid, dicyclomet, and fenoxanil;
F.X) a plant defense inducer selected from the group consisting of
acibenzolar-5-methyl, probenazole, isotianil, tiadinil, prohexadione-calcium; phosphonates: fosetyl, fosetyl-aluminum, phosphorous acid and its salts;
F.XI) a compound with an unknown mode of action selected from the group consisting of
bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxin-copper, proquinazid, tebufloquin, tecloftalam, triazoxide, 2-butoxy-6-iodo-3-propylchromen-4-one, N-(cyclo-propylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester, N-Methyl-2-{1-[(5-methyl-3-trifluoromethyl-1H-pyrazol-1-yl)-acetyl]-piperidin-4-yl}-N-[(1R)-1,2,3,4-tetrahydro-naphthalen-1-yl]-4-thiazolecarboxamide, 3-[5-(4-methyl-phenyl)-2,3-dimethyl-isoxazolidin-3-yl]-pyridine, 3-[5-(4-chloro-phenyl)-2,3-dimethylisoxazolidin-3-yl]-pyridine (pyrisoxazole), N-(6-methoxy-pyridin-3-yl)cyclopropane-carboxylic acid amide, 5-chloro-1-(4,6-dimethoxy-pyrimidin-2-yl)-2-methyl-1H-benzoimidazole, an 2-(4-chloro-phenyl)-N-[4-(3,4-dimethoxy-phenyl)-isoxazol-5-yl]-2-prop-2-ynyloxy-acetamide;
in a synergistically effective amount.

34. The agricultural mixture according to claim 33, wherein in the active compound I of formula (I)
R¹ is 2,2,2-trifluoroethyl.

35. The agricultural mixture according to claim 33, wherein in the active compound I of formula (I)
R³ is selected from the group consisting of hydrogen, fluorine, chlorine, methyl and trifluoromethyl;
and
R² is selected from the group consisting of chlorine, methyl, difluoromethyl, trifluoromethyl and cyano.

36. The agricultural mixture according to claim 33, wherein in the active compound I of formula (I)
R³ is fluorine;
and
R² is methyl.

37. The agricultural mixture according to claim 33, wherein in the active compound I of formula (I) k is 0.

38. The agricultural mixture according to claim 33, wherein in the active compound I of formula (I)
k is 1, 2 or 3
and
R⁴ is selected independently from the integer of k from fluorine, chlorine, cyano, methyl, trifluoromethyl, methoxy, difluoromethoxy and trifluoromethoxy.

39. The agricultural mixture according to claim 33, wherein in the active compound I of formula (I-A) 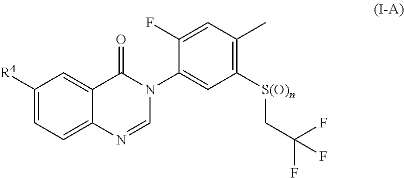
n is 0 or 1.
and
R⁴ is selected from fluorine, chlorine, cyano, methyl, trifluoromethyl, methoxy, difluoromethoxy and trifluoromethoxy

40. The agricultural mixtures according to claim 33, wherein in the active compound I is of formula (I-B) 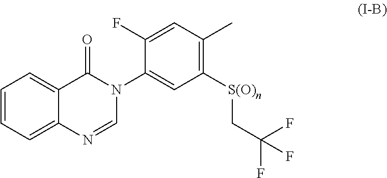
n is 0 or 1.

41. The agricultural mixture according to claim 33, wherein at least one active compound II is selected from the group consisting of azoxystrobin, fluoxastrobin, picoxystrobin, pyraclostrobin and trifloxystrobin.

42. The agricultural mixture according to claim 33, wherein the active compound II is cyazofamid.

43. The agricultural mixture according to claim 33, wherein at least one active compound II is selected from the group consisting of bixafen, boscalid, fluopyram, fluoxapyroxad, isopyrazam, penflufen, penthiopyrad and sedaxane.

44. The agricultural mixture according to claim 33, wherein at least one active compound II is selected from ametoctradin and silthiofam.

45. The agricultural mixture according to claim 33, wherein at least one active compound II is selected from the group consisting of difenoconazole, epoxiconazole, fluquinconazole, flusilazole, flutriafol, ipconazole, metconazole, prothioconazole, tebuconazole, triticonazole and prochloraz.

46. The agricultural mixture according to claim 33, wherein at least one active compound II is selected from metalaxyl, mefenoxam (metalaxyl-M) and propineb.

47. The agricultural mixture according to claim 33, wherein at least one active compound II is selected from the group consisting of benomyl, carbendazim and thiophanatemethyl.

48. The agricultural mixture according to claim 33, wherein at least one active compound II is selected from the group consisting ethaboxam, fluopicolide and pyriofenone

49. The agricultural mixture according to claim 33, wherein at least one active compound II is dimethomorph.

50. The agricultural mixture according to claim 33, wherein at least one active compound II is sulfur.

51. The agricultural mixtures according to claim 33, wherein at least one active compound II is a copper salt selected from copper acetate, copper hydroxide, copper oxychloride or basic copper sulfate.

52. Agricultural mixture according to claim 33, wherein at least one active compound II is selected from mancozeb or metiram.

53. The agricultural mixture according to claim 33, wherein at least one active compound II is chlorothalonil.

54. The agricultural mixture according to claim 33, wherein at least one active compound II is selected from phosphorous acid or its salts.

55. The agricultural mixture according to claim 33, comprising the active compound I of the formula I and the active compound II in a weight ratio of from 500:1 to 1:100.

56. A method for protecting plants from attack or infestation by insects, acarids or nematodes comprising contacting the plant, or the soil or water in which the plant is growing, with a mixture according to claim 33 in pesticidally effective amounts.

57. A method for controlling insects, arachnids or nematodes comprising contacting an insect, acarid or nematode or their food supply, habitat, breeding grounds or their locus with a mixture according to claim 33 in pesticidally effective amounts.

58. A method for protection of plant propagation material comprising contacting the plant propagation material with a mixture as defined in claim 33 in pesticidally effective amounts.

59. Seed treated with the mixture according to claim 33 in an amount of from 0.1 g to 10 kg per 100 kg of seeds.

60. A method for controlling phytopathogenic harmful fungi, wherein the fungi, their habitat or the plants or the plant propagation material to be protected against fungal attack, the soil or seed are treated with a fungicidal effective amount of a mixture of at least one active compound I and at least one active compound II according to claim 33.

61. A method for protecting plants from phytopathogenic harmful fungi, wherein the fungi, their habitat or the plants or the plant propagation material to be protected against fungal attack, the soil or seed are treated with a fungicidal effective amount of a mixture of at least one active compound I and at least one active compound II according to claim 33.

62. Agricultural composition, comprising a liquid or solid carrier and a mixture according to claim 33.
